(19) United States
(12) Patent Application Publication
(10) Pub. No.: US 2014/0343245 A1
(43) Pub. Date: Nov. 20, 2014

(54) Plasma Treatment of Halogenated Compounds

(71) Applicants: Thomas Scott Molloy, Lindfield (AU); Bogdan Dlugogorski, Lindfield (AU); Eric Kennedy, Lindfield (AU)

(72) Inventors: Thomas Scott Molloy, Lindfield (AU); Bogdan Dlugogorski, Lindfield (AU); Eric Kennedy, Lindfield (AU)

(73) Assignee: PACIFITECH PTY LTD, Lindfield, New South Wales (AU)

(21) Appl. No.: 14/344,746

(22) PCT Filed: Sep. 14, 2012
(86) PCT No.: PCT/AU2012/001105

§ 371 Date: Mar. 13, 2014

(30) Foreign Application Priority Data
Sep. 14, 2011 (AU) 2011903776
Sep. 21, 2011 (AU) 2011903874

(51) Int. Cl. C08G 61/04; B01J 19/08

(52) U.S. Cl. CPC C08G 61/04; B01J 19/08; B01J 2219/0894
USPC 528/397; 422/131

(57) ABSTRACT

A method and an apparatus for the non-thermal plasma processing of halogenated compounds. A non-thermal plasma reactor (110) with a non-thermal plasma reaction zone (116) may process one or more halogenated compounds diluted in an inert carrier gas in a gas stream (114). An alkane gas may also be added to the gas stream (114) for some halogenated compounds. A uniform polymer product may be deposited within the non-thermal plasma reactor apparatus, the polymer being derived from molecular fragments of the reactant halogenated compound and the reactant alkane gas if present. The non-thermal plasma may be provided by the use of a dielectric barrier discharge technique utilizing two co-axial dielectric tubes (126, 128) with corresponding high voltage (136) and ground (138) electrodes.

### BACKGROUND OF THE INVENTION

1. Field of the Invention

The present invention relates to a process and an apparatus for a processing of halogenated compounds to polymers by use of a non-thermal and/or non-equilibrium plasma. The halogenated compounds may include hydrocarbons, fluoro-carbons, chloro-carbons and combinations of carbon based compounds.

2. Description of the Art

Halogenated, often carbon based compounds have been found to have many uses, for example the use of fluorocarbons, halofluorocarbons and hydrofluorocarbons as refrigerants and propellants, halons (i.e. chlorinated and/or brominated saturated fluorocarbons) as flame suppressants used in fire fighting and perfluorocarbon as foam blowing agents. In addition chlorinated hydrocarbons such as chlorinated methanes and ethanes may be used to manufacture vinyl chloride, tetrachloroethylene, ethylenediamines, azridines as well as chlorinated solvents. However, many of these useful halogenated organic compounds have been found to be damaging to the environment and/or to humans.

The use and production of some fluorocarbons are now restricted or banned under international treaties. Enormous stockpiles of halons, chlorofluorocarbons (CFCs) and other fluorocarbon pollutants exist internationally and there is a need for techniques for their disposal.

Techniques for disposal of these pollutants typically include destructive processes such as incineration and high temperature plasma destruction. High temperature plasmas typically being >1,000 K and often in excess of 3,000 K within the plasma for all components (i.e. ions, neutral atoms and free electrons). Such incineration and high temperature plasma processes are expensive to run, may result in incomplete destruction of the halogenated compounds and produce compounds of no particular economic value. High temperature plasma destruction is suitable for dilute concentrations of some fluorocarbons, but not for halons in view of their flame suppressive properties. Other proposed disposal processes include hydrolysis, steam reforming, dehalogenation and dehydrohalogenation. Incineration remains the most widely adopted technology for fluorocarbon disposal.

Non-thermal plasmas have also been applied to the destruction of halogenated compounds, for example U.S. Pat. No. 5,387,775. A non-thermal plasma may be generated in the manner of a dielectric barrier discharge lamp with radio frequency generation techniques, for example US 2011/0101858.

Non-thermal plasmas have also been used for the co-conversion of some organic compounds to lower molecular weight compounds, for example US 2003/0051993 and U.S. Pat. No. 7,494,574.

None of these prior art devices or processes provides an entirely satisfactory solution to the provision of processing or converting of halogenated compounds to a polymer with a non-thermal plasma, nor to the ease of construction of a non-thermal plasma reactor apparatus for a production of a variety of polymers.

### SUMMARY OF THE INVENTION

The present invention aims to provide an alternative non-thermal plasma processing method and apparatus which overcomes or ameliorates the disadvantages of the prior art to the production of polymer compounds, polymer precursors and/or other useful compounds from halogenated compounds, or at least provides a useful choice.

In one form, the invention provides a process for producing a polymer from a gas stream containing a halogenated compound, comprising the steps: providing the gas stream including the halogenated compound and a carrier gas portion, the carrier gas portion being suitable for producing a non-thermal plasma; providing a non-thermal plasma reaction zone; exposing to and/or exciting and/or dissociating the gas stream within the non-thermal plasma reaction zone; and one or more of condensing and depositing from the gas stream the polymer/s. The carrier gas may be an inert gas such as helium, neon, argon, krypton and xenon. Preferably the inert gas is argon. Optionally the process may further include the step of selecting an alkane gas and/or a hydrogen gas for a portion of the gas stream. The alkane gas may also be optionally selected on the basis of when hydrogen is absent or in a low proportion within the halogenated compound. The alkane gas may be selected from the group consisting of methane, ethane, propane and butane. Preferably the alkane gas is methane.

Preferably the process includes the step of selecting the gas stream composition such that the gas stream is non-oxidative in the non-thermal plasma reaction zone. Optionally the process includes maintaining the gas stream at an approximate atmospheric pressure.

The halogenated compound may be optionally selected from the group consisting of one or more of fluorocarbons, halofluorocarbons and hydrofluorocarbons, chlorinated saturated fluorocarbons, brominated saturated fluorocarbons, halon, halogenated organic compounds, chlorofluorocarbons, dichlorodifluoromethane, PFOS (perfluoroctanesulfonic acid), PFOA (perfluorooctanoic acid), HCB-(hexachlorobenzene), PCB (polychlorinated biphenyls), brominated flame retardants (HBCD, TBBPA), halogenated pesticides, dieldrin, aldrin, DDT, 2,4 D and 2,4,5 T. Preferably the halogenated compound may be selected from the group consisting of CCl₂F₂, CFCl₂Br, CF₃Br, CF₃H, CHClF₂, C₄F₁₀, CH₂F₂, CF₃H, C₃F₈, C₃F₈O, CF₃Br, CF₂ClBr, CF₂CFH, C₂H₃F, C₂H₂F₂, C₂H₂F₂ and CCl₃F.

The halogenated compound may also be optionally selected from the group consisting of chlorinated alkanes, chlorinated hydrocarbons, PFOS (perfluoroctanesulfonic acid), derivatives of PFOS (perfluoroctanesulfonic acid), PFOA (perfluorooctanoic acid), derivatives of PFOA (perfluorooctanoic acid), HCB-(hexachlorobenzene), PCB (polychlorinated biphenyls), brominated flame retardants (HBCD, TBBPA), halogenated pesticides, dieldrin, aldrin, DDT, 2,4 D and 2,4,5 T. Preferably the halogenated compound may be selected from the group consisting of dichloroethane, dichloromethane and trichloromethane.

The process may further include a polymer which is one or more of a uniform polymer, may have a Polydispersity Index in the approximate range of 1 to 2, a Polydispersity Index in the approximate range of 1.0 to 1.1 and a Polydispersity Index of approximately 1.1.

Optionally the process may further include one or more of the steps: dissolving the polymer in tetrahydrofuran, recovering the polymer with tetrahydrofuran, and recovering and purifying of polymer products using selective solubility and precipitation methods.

Preferably selecting a concentration of the halogenated compound in the gas stream to be less than approximately 2%. Optionally the process is one where one or more of a fluorine gas and a chlorine gas are substantially absent from the exposed/product/treated gas stream Preferably a proportion of a HF acid in a total of all gas phase products in the exposed/product gas stream may be less than or approximately equal to 4.4%.

Optionally the proportion of a halogen from the halogenated compound that may be bound within the polymer is up to approximately 58% or up to approximately 41%. Preferably the bound halogen is selected from the group consisting of chlorine and fluorine.

The halogenated compound may be in the form of at least one of a gas, a liquid, a powder, a solid and a powder suspended in a liquid.

In an alternate form the invention provides a process for producing a polymer from a gas stream containing one or more halogenated compounds, with the steps of: providing a non-thermal plasma reaction zone by means of a non-thermal plasma apparatus; exposing or otherwise treating or exciting the gas stream with the non-thermal plasma reaction zone; and one or more of condensing and depositing from the gas stream the polymer.

In a further form, the invention provides a polymer produced according to the process and its options summarised above. The polymer may be substantially as described herein with respect to one or more of the NMR spectra. Furthermore the polymer may be substantially as described herein with respect to one or more functional groups and/or with respect to one or more gel permeation chromatography graphs and/or with respect to one or more of a number average molecular weight, a weight average molecular weight and a Polydispersity Index. Preferably the polymer may not be substantially cross-linked

In yet another alternate form the invention provides a process for producing a polymer from a halogenated compound substantially as described herein as well as an apparatus for producing a polymer from a halogenated compound substantially as described herein.

In another alternate form, the invention may comprise a non-thermal plasma reactor apparatus for production of a polymer from a gas stream containing a halogenated compound, comprising: a means for generating a non-thermal plasma reaction zone; a means for providing the gas stream to the non-thermal plasma reaction zone; and a means for depositing a polymer/s from the gas stream to a deposition surface at one or more of within the non-thermal plasma reaction zone and downstream of the non-thermal plasma reaction zone. Preferably the means for generating a non thermal plasma reaction zone includes a dielectric barrier discharge apparatus. Optionally the means for generating a non thermal plasma reaction zone includes two co-axial dielectric tubes and at least two electrodes. Preferably the means for providing the gas stream includes an inlet manifold and an outlet manifold. Optionally the gas stream may be at approximately atmospheric pressure.

Further forms of the invention are as set out in the appended claims and as apparent from the description.

### DISCLOSURE OF THE INVENTION

### BRIEF DESCRIPTION OF THE DRAWINGS

The description is made with reference to the accompanying drawings; of which:

FIG. 1A is a schematic partial sectional view of a non-thermal plasma reactor apparatus 110 in an embodiment of the invention.

FIG. 1B is a schematic of a cross-sectional and enlarged view of the circled region in FIG. 1A.

FIG. 2 is a schematic diagram of the non thermal plasma reactor apparatus of FIG. 1A together with supporting apparatus.

FIG. 3 is a circuit diagram of the circuit used for averaged power measurement.

FIG. 4 is a Lissajous figure from an oscilloscope connected to the circuit of FIG. 3.

FIG. 5 is a graph of input power to the non-thermal plasma reactor of FIG. 1 versus the applied voltage to the electrodes of the reactor.

FIG. 6 is an example Fourier transform infrared (FTIR) gas phase spectrum for a fluorocarbon, CFC-12, processed with methane.

FIG. 7 is a gel permeation chromatography (GPC) trace of a polymer resulting from CFC-12 and methane in the reactor of FIG. 1.

FIG. 8 is a one dimensional ¹³C NMR spectrum for a polymer derived from a fluorocarbon, CFC-12, and methane.

FIG. 9 is a one dimensional DEPTQ ¹³C NMR spectrum for the polymer derived from CFC-12 and methane.

FIG. 10 is a graph of a percentage conversion of a dichloroethane (DCE) in the non-thermal plasma versus the applied voltage to the non-thermal plasma apparatus of FIG. 1A.

FIG. 11 is a graph of a yield of vinyl chloride in the gas phase products from the non-thermal plasma treatment of DCE versus the applied voltage to the non-thermal plasma apparatus of FIG. 1A.

FIG. 12 is a graph of the yield of ethylene (H₂C═CH₂) in the gas phase from the non-thermal plasma treatment of DCE versus the applied voltage.

FIG. 13 is the GPC results for the solid product from DCE at an applied voltage of 12 kV to the non-thermal plasma.

FIG. 14 is a one dimensional DEPT ¹³C NMR spectrum for the polymer derived from DCE for the applied voltage of 12 kV for the non-thermal plasma.

FIG. 15 is a one dimensional ¹³C NMR spectrum for the polymer of FIG. 14.

FIG. 16 is a two dimensional (2D) NMR spectrum of the polymer of FIG. 14.

FIG. 17 is a two dimensional COSY NMR spectrum of the polymer of FIG. 14.

FIG. 18 is a further two dimensional COSY NMR spectrum to the polymer of FIG. 14.

FIG. 19 is an alternate embodiment of FIGS. 1A, 1B and 2.

FIG. 20 is a further one dimensional ¹³C NMR spectrum for the polymer of FIG. 14.

FIG. 21 is a further one dimensional DEPT ¹³C NMR spectrum for the polymer of FIG. 14.

FIG. 22 is a further one dimensional DEPTQ ¹³C NMR spectrum for the polymer of FIG. 14.

FIG. 23 is a ¹⁹F NMR spectrum for the polymer of FIG. 14.

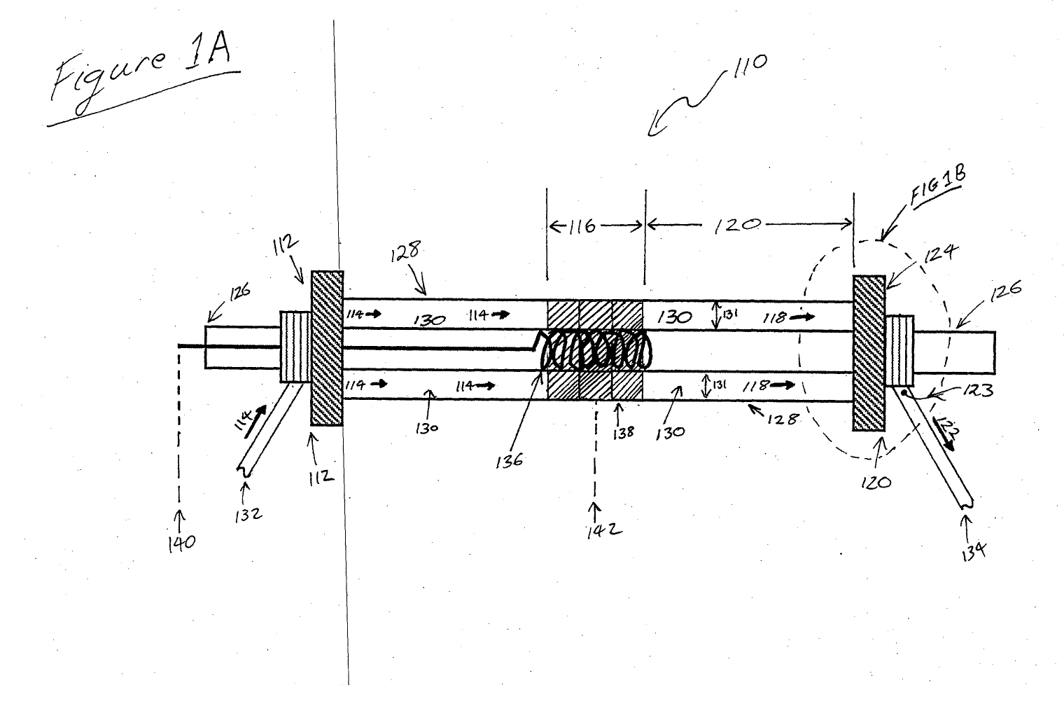

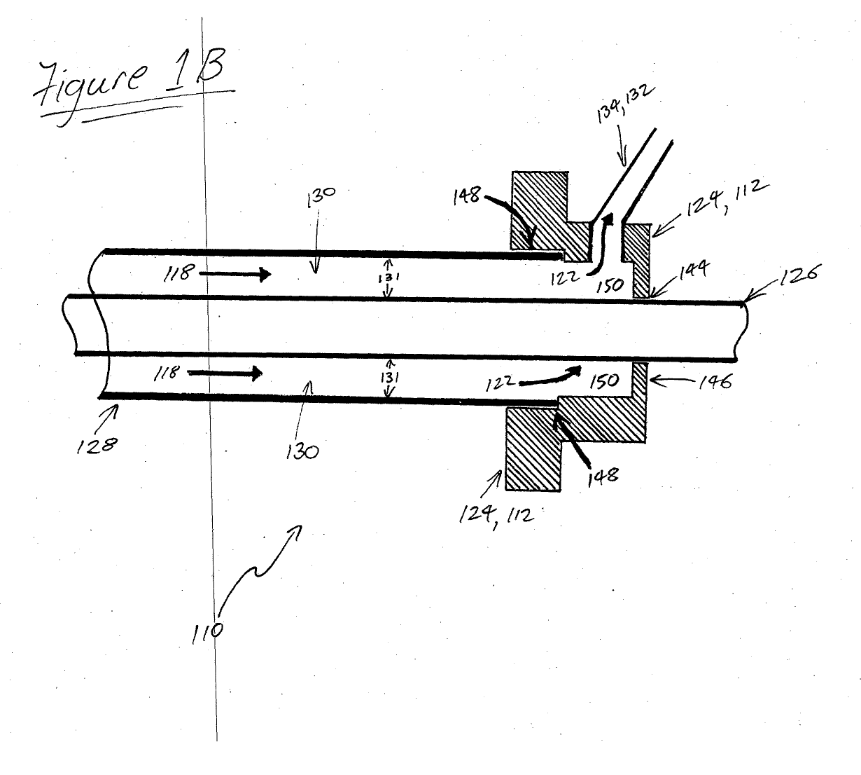

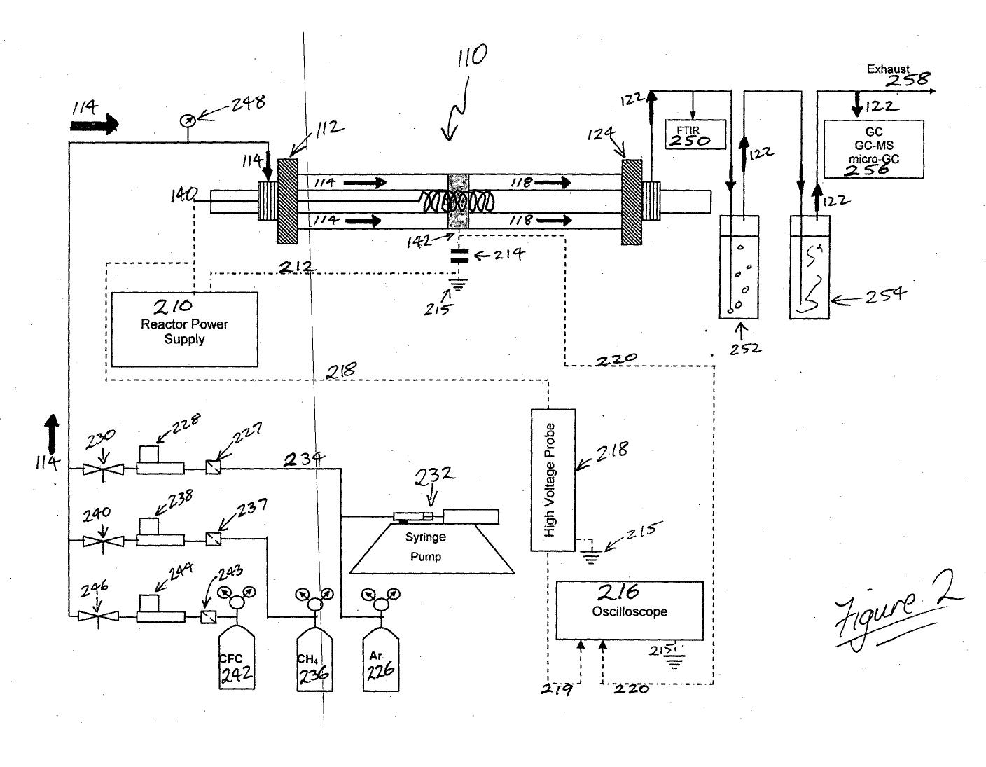

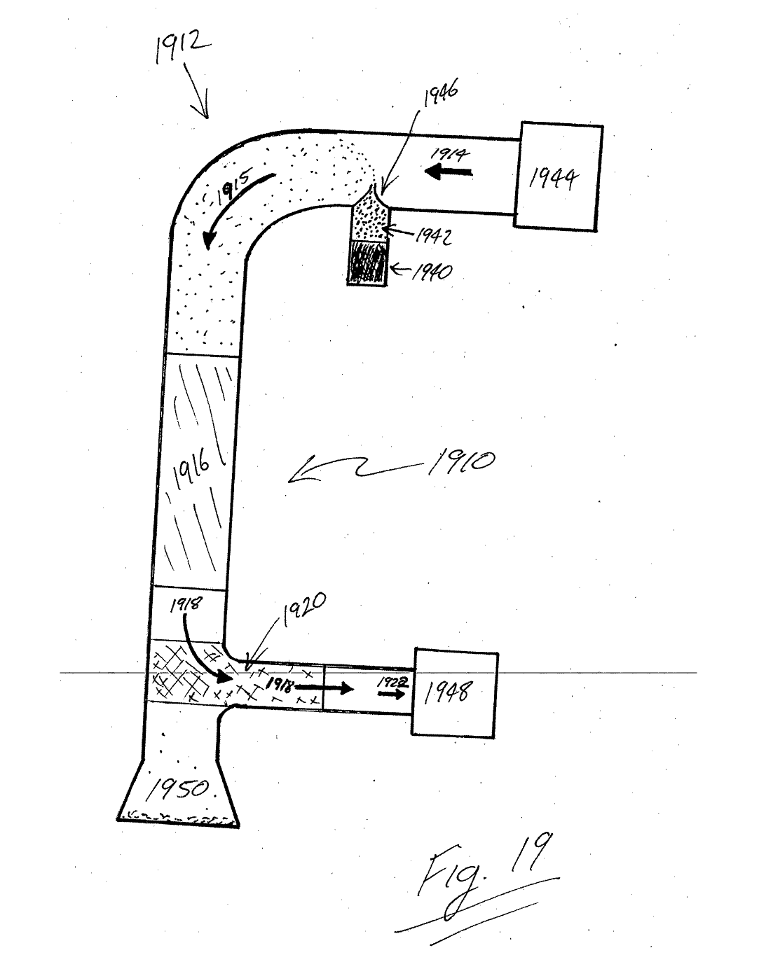

In FIG. 1A, as well as generally in this description, the reference numerals are allocated by analogy to or prefixed by the figure number; for example FIG. 1A is the “100” series, FIG. 2 is the “200” series and so on. In addition like features between different embodiments of different figures may be indicated by like reference numerals, for example the plasma reactor apparatus 110 of FIG. 1A and the alternate, vertical plasma reactor apparatus 1910 of FIG. 19.

Open, thin arrows are used to indicate an item for example a plasma reactor apparatus 110 in FIG. 1A. Solid arrows are used to indicate the flow of quantities such as gases, liquids and solid materials, for example a gas stream 114 arrow in FIG. 1A.

### DETAILED DESCRIPTION OF THE PREFERRED EMBODIMENTS

FIG. 1A is a schematic partial sectional view of a plasma reactor apparatus 110 in an embodiment of the invention. FIG. 1A is not drawn to scale. The plasma reactor 110 may have an inlet manifold section 112 that connects a gas stream 114, containing one or more halogenated compound/s to a non-thermal plasma reaction zone 116.

The gas stream 114 may include an inert gas such as helium, neon, argon, krypton and xenon or a mixture of inert gases selected to aid in providing the non-thermal plasma as well as being a carrier gas for the halogenated compounds. The use of a carrier gas with the halogenated compounds diluted in the carrier gas allows the plasma reactor 110 to be operated at an atmospheric pressure and/or an ambient pressure. The use of an inert gas also enables a non-oxidative environment to be maintained throughout the apparatus and process. A preferred inert gas is argon.

The gas stream 114 may also include an alkane gas such as methane, ethane, propane and butane either singly or in a mixture of alkane gases and/or other gases such as hydrogen. A preferred alkane gas is methane.

The halogenated compound/s within the gas stream may be exposed to the non-thermal plasma in the non-thermal plasma reaction zone 116 to be converted to a polymer or a polymer blend. The gas stream within the non-thermal plasma reaction zone 116 may be excited and components of the gas stream such as the halogenated compounds may also be excited and dissociated into excited molecular fragments. The halogenated compound may also be converted to precursors and/or intermediate species, for example monomers and oligomers, of a polymer or a polymer blend. The use of the alkane and/or hydrogen gas/es may also provide molecular fragments within the plasma reaction zone 116 for combination with the monomers and oligomers derived from exposure of the halogenated compounds to the non thermal plasma and/or molecular fragments of the halogenated compounds.

The exposed gas stream or product gas stream 118, as shown by the solid arrow, exits the non-thermal plasma reaction zone 116 into a condenser section 120 where a polymer and/or polymer blend from the exposed gas stream 118 condenses and/or otherwise deposits onto one or more comparatively cool surface/s of the condenser 120. The polymer and/or polymer blend may also condense and/or otherwise deposit upon one or more surfaces within the non-thermal reaction zone 116. The surfaces for polymer deposition may include respective surfaces of an inner dielectric tube 126 and a co-axial outer dielectric tube 128. After the condenser 120 a cooled, exposed/product/treated gas stream 122 exits the plasma reactor 110 via an outlet manifold 124 for further, optional treatment and analysis as described below with respect to FIG. 2.

“Non-thermal plasma”, unless the contrary indication appears, is taken to include one or more of: “RF plasma”, glow discharge plasma, non-equilibrium plasma or cold plasma. Typically a non-thermal plasma may not feature arc discharges, sparks and/or streamer channels. In addition a non-thermal plasma may also be further described as a plasma which may have high free electron temperatures, possibly up to many thousands of Kelvin; whilst the ions and neutral atoms may predominantly be near room/ambient temperature, for example approximately 70° to 200° C. In comparison other “hot” plasmas may have all components in the hot plasma at temperatures at approximately 1,000 K to 3,000 K or higher.

The inventors have observed that when a non-thermal plasma has been established with only pure argon in the gas stream 114, filaments and/or streamer channels may be apparent in the non-thermal plasma. However when a halogenated compound and/or an alkane gas are added to the gas stream 114 the streamers and filaments are no longer present and a more homogeneous discharge may be apparent in the modified argon discharge.

A diffuse and/or homogenous discharge for a non-thermal plasma may be classified as a Townsend type or glow type; also commonly described as, atmospheric pressure Townsend discharge (APTD) and atmospheric pressure glow discharge (APGD). The non-thermal plasma described and used herein may be classified as in the regime of a homogenous (or diffuse) glow discharge. In other words the non-thermal plasma here may be described as a hybridized discharge operating in the transition space between homogeneous glow and filamentary discharge regimes.

### Non Thermal Plasma Reactor Apparatus.

The non thermal plasma reactor apparatus of FIG. 1A features two co-axial, dielectric tubes or cylinders 126, 128. The dielectric tubes 126, 128 may be made of alumina, quartz or any other material as selected by a person skilled in the art. For example the person skilled in the art may select a suitable dielectric material on the basis that the dielectric properties and wall thickness of a tube must have sufficient dielectric strength to prevent a breakdown of the material at an applied voltage. The dimensions of two embodiments are described below with respect to experiments with fluorocarbons and 1,2-dichloroethane (C₂Cl₂H₄ or “DCE”). By way of example the inner dielectric tube 126 may have an outer diameter in the approximate range of 10 to 15 mm with a wall thickness in the approximate range of 1 to 2 mm. The outer dielectric tube 128 may have an outer diameter in the approximate range of 20 to 30 mm with a wall thickness in the approximate range of 1 to 3 mm. The length of dielectric tubes 126, 128 between the inlet and out manifolds 112, 124 may be in the approximate range of 250 mm to 350 mm or more preferably 300 mm.

In the fluorocarbon work described below alumina (99.8% purity) tubes were used with approximate dimensions of: the outer tube 128 had an outer diameter of approximately 23 mm with a wall thickness of approximately 2.0 mm whilst the inner tube 126 had an outer diameter of approximately 10 mm with a wall thickness of approximately 1.0 mm. In the DCE work described below quartz tubes were used with approximate dimensions of: the outer tube 128 had an outer diameter of approximately 25 mm with a wall thickness of approximately 1.8 mm whilst the inner tube 126 had an outer diameter of approximately 12 mm with a wall thickness of approximately 1.5 mm.

The inlet and outlet manifolds 112, 124 may constructed so as to support the inner and outer dielectric tubes 126, 128 as shown in FIG. 1A in a concentric/co-axial cylindrical arrangement, as well as to isolate an annular space 130 between the outer surface of the inner dielectric tube 126 and the inner surface of the outer dielectric tube 128. It will be readily appreciated by a person skilled in the art that the materials that may be used to construct the inlet and outlet manifolds are fit for purpose structurally as well as highly resistant to chemical attack for example PTFE. The manifolds 112, 114 and the dielectric tubes 126, 128 are described in more detail below with respect to FIG. 1B.

A gap dimension 131 of the annular space 130 between the inner surface of the outer dielectric tube 128 and the outer surface of the inner dielectric tube 126 was approximately 4.5 mm for the fluorocarbon work of below. For the DCE work of below the gap 131 dimension was approximately 4.7 mm.

The inlet and outlet manifolds 112, 114 also have internal channels (not shown) to allow respectively: the gas stream 114 to enter via an inlet pipe 132 the inlet manifold 112 and then to the annular space 130. Similarly for the cooled, exposed gas stream 122 to exit the annular space 130 via the outlet manifold 124 and into the outlet pipe 134. In addition the internal channels of the inlet and outlet manifolds may be sculpted to improve the gas stream 114, 118 flow characteristics and presentation to the non-thermal plasma reaction zone 116 and condenser 120. For example some turbulent and/or mixing flow may be present to facilitate deposition of the polymer to a surface as well as mixing reactants, precursors and intermediate species within the non-thermal plasma reaction zone 116. A cross-sectional view of an embodiment of the manifolds 112, 114 is described below with respect to FIG. 1B.

A temperature probe 123 may be inserted into the exposed/product gas stream 118, 122 in order to measure a gas temperature for the exposed gas stream 118, 122. Temperature measurements may also be made at or about the ground electrode as well as along the outer surface of the outer dielectric tube 128.

A high voltage electrode 136 in a form of a helical coil may be located within the inner dielectric tube 126 to correspond with the non-thermal plasma reaction zone 116 as shown in FIG. 1A. A corresponding ground electrode 138 may be located about the outer surface of the outer dielectric tube 128 as shown in partial section in FIG. 1A. A high voltage connection 140 and a ground connection 142 connect respectively the high voltage electrode 136 and ground electrode 138 to a plasma power supply which is described below with respect to FIG. 2. The high voltage and ground connections 140, 142 also connect to voltage, current and power measurement apparatus as described below with respect to FIG. 2.

Preferably the length of the high voltage electrode 136 along the dielectric tubes 126, 128 is approximately the same as the length along the tubes for the ground electrode 138. More preferably the high voltage electrode 136 may be approximately 5 to 20% longer than the ground electrode 138 length along the tubes. The slightly longer high voltage electrode 136 length may serve to improve plasma homogeneity for example by improving an electric field distribution with a longer electrode to reduce the contribution of higher intensity plasma regions that may be associated with non-uniform electric field intensities about the ends of the high voltage electrode 136. In the fluorocarbon and DCE work of below the high voltage electrode 136 length along the inner tube 126 was approximately 6 mm more than the corresponding ground electrode 138.

The approximate length of the ground electrode 138 along the tubes 126, 128 may be in the approximate range of 20 to 30 mm. For the fluorocarbon work the ground electrode length was approximately 24 mm. In the DCE work the ground electrode length was 20 mm. The length of the ground electrode 138 may approximate the length of the non-thermal plasma reaction zone 116, where the length of the ground electrode along the outer dielectric tube 128 is less than the length of the high voltage electrode 136 along the inner dielectric tube 126. It will be readily appreciated by the person skilled in the art that the length of the plasma reaction zone 116 may be readily varied according to the desired residence time in the plasma reaction zone 116 for the halogenated compounds in the gas stream 114. Experimental examples of residence times are described below.

The high voltage electrode 136 may have a coil outer diameter approximately corresponding to the inner diameter of the inner dielectric tube 126 or as suitable for the high voltage electrode 136 to fit within the inner dielectric tube 126 in close physical contact, for example a sliding fit. The number of turns in the helical coil may be in the approximate range of 5 to 30. Preferably the number of turns in the helical coil may be in the approximate range of 7 to 15. The wire used for constructing the high voltage electrode 136 may be of a gauge and material as selected by a person skilled in the art for the radio frequency voltage generation used, see below with respect to FIG. 2. For example copper wire may be used with a diameter in the approximate range of 1 to 2 mm.

The ground electrode 138 may be formed of a suitable metal such as copper shim wrapped about the outer surface of the outer dielectric tube 128. Further details to the arrangement and energising of the high voltage electrode 136 and ground electrode are provided below within the further detailed descriptions.

Advantageously the high voltage electrode 136 and the corresponding ground electrode 138 are both situated outside of the annular space 130. The walls of the dielectric tubes 126, 128 contributing to the ease of production of the non-thermal plasma as well as protecting the electrodes 136, 138 from chemical and plasma erosion and/or attack.

FIG. 1B is a cross-sectional and enlarged view of the circled region in FIG. 1A. The outlet manifold 124 is only shown in cross-section in FIG. 1B, however the same features described for the outlet manifold 124 may also be applied to the inlet manifold 112. The inner dielectric tube 126 passes through an aperture 144 of an end face 146 or outer face 146 of the manifold 124, 112 as shown in FIG. 1B. The end face 146 aperture 144 of the manifold 124, 112 suitably supports, centers and seals the inner dielectric tube 126 as may be readily designed and constructed by a person skilled in the art. The outer dielectric tube 128 is located in a recess 148 machined within the manifold 124, 112. The recess 148 locates, supports, positions and seals the outer dielectric tube 128 such that the annular space 130 is formed between the two dielectric tubes 126, 128. A further annular space 150 is also formed within the manifold 124, 112 to the centered inner dielectric tube 126. At a wall of the further annular space 150 the outlet/inlet pipe 134, 132 is connected to the manifold to allow the gas stream 122, 114 to exit the plasma reactor apparatus 110. A filter plug (not shown) may also be present in the inlet pipe 132 at the connection to the manifold.

### Delivery System—Supporting Apparatus—Gas Products Analytical System

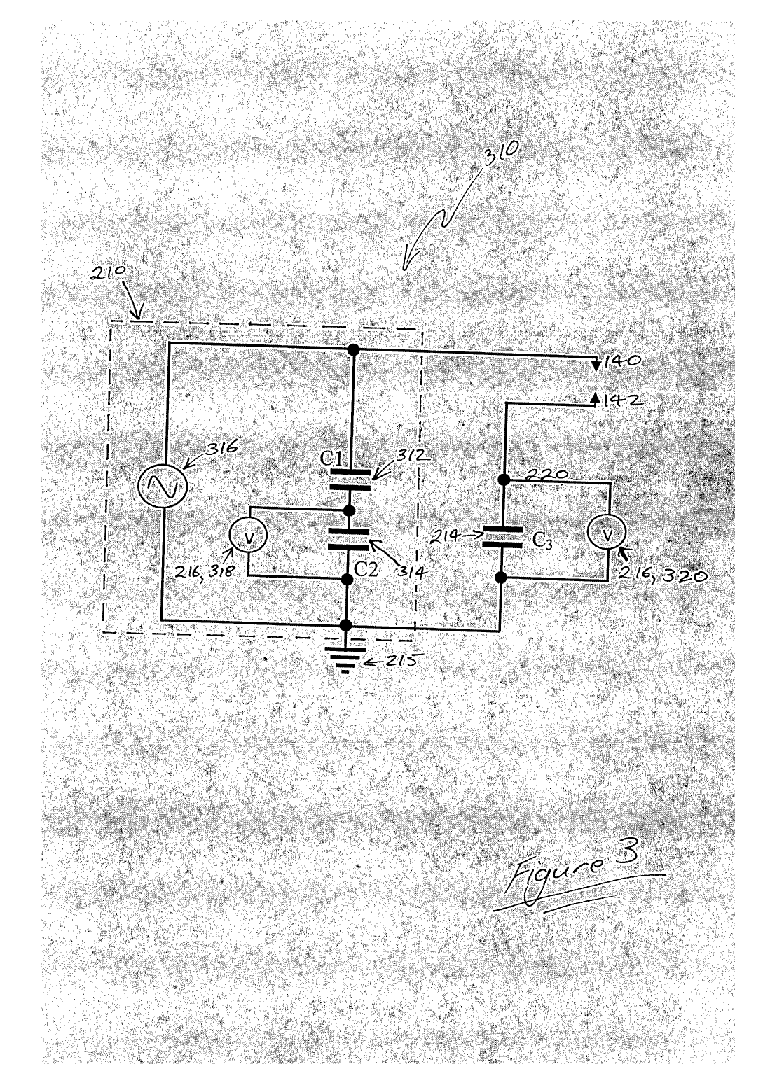

FIG. 2 is a schematic diagram of the non thermal plasma reactor 110 together with supporting apparatus. A plasma power supply 210 is connected via the high voltage connection 140 to the high voltage electrode 136. The ground 212 of the power supply 210 may be optionally connected via a current integrating capacitor 214 to the ground connection 142 of the plasma reactor 110. Alternatively the power supply ground 212 may be connected directly to the ground connection 142, without the current integrating capacitor 214. The power supply ground 212 and current integrating capacitor 214 may also be connected to the common ground 215. An oscilloscope 216 may be used in measurement of instantaneous (continuous) voltage, current and averaged power to the plasma reactor 110. Instantaneous voltage measurement may be made by use of a high voltage probe (3450:1) 218 that may be used to connect a voltage input 219 of the oscilloscope 216 with the high voltage connection 140 of the plasma reactor 110. The high voltage values provided here are given as kilovolts (kV) of the peak to peak (pk-pk) sinusoidal waveform. Instantaneous current measurement may be made by connecting 220 the oscilloscope 216 to a current sensing resistor (not shown) which may be substituted for the current integrating capacitor 214. The current sensing resistor may be 50 ohms or a suitable resistor as selected by a person skilled in the art. Instantaneous current measurement may be made by monitoring the voltage potential across the current sensing resistor. In FIG. 2 the connection 220 between the oscilloscope and the current integrating capacitor 214 is in a configuration for the averaged power measurement, described in detail below with respect to FIGS. 3 to 5.

The inert carrier gas 226 for the gas stream 114 line may be controlled with a mass flow controller 228 and a toggle valve 230. A gas filter 227 may also be used for the inert carrier gas 226. For the DCE halogenated compound work a gas syringe pump 232 may also inject into the inert carrier gas line 234. The alkane gas 236 for the fluorocarbon work was also supplied with a dedicated gas filter 237, mass flow controller 238 and a dedicated toggle valve 240. The fluorocarbons 242 were connected as required to another dedicated gas filter 243, mass flow controller 244 and toggle valve 246. Mixing of all the gases in the gas stream 114 occurred as the gas stream 114 flowed to the inlet manifold 112 of the non-thermal plasma reactor for processing as described above with respect to FIGS. 1A and 1B and further below. A pressure gauge 248 for the gas stream 114 line was used to monitor that the pressure was approximately atmospheric and/or ambient.

The cooled exposed/product/treated gas stream 122 from the outlet manifold 124 was then optionally passed to online gas analysis by a Fourier Transform Infrared Spectrometer (FTIR) and then through a caustic soda (NaOH) liquid scrubber 252 and caustic soda (NaOH) pellet drier to make the exposed gas stream 122 suitable for multiple gas chromatography 256 analyses. Excess exposed gas 122 may be exhausted 258 for disposal.

The analysis of acid gases in the exposed/product gas stream 122 was performed by a Perkin-Elmer Fourier transform infrared spectrometer (Spectrum 100) 250. This FTIR was equipped with a very short path length (11.7 mm) acid-resistant gas cell of PTFE together with KBr windows. The gas cell was custom made with a very short path length and high acid resistance for this particular measurement application. The resolution for all scans was 1.0 cm⁻¹. The spectra were processed (QASoft) to obtain absorption spectra and externally calibrated. The external calibration was performed by individually producing acid gases in situ by a separate thermal reactor, calibration gases for fluorocarbon and methane to the FTIR. Then obtaining an infrared spectrum (reference spectrum) for each gas stream through the FTIR cell and finally passing through two caustic soda solution scrubbers for a known time to convert them into halide salts for the acid gases. An ion-chromatograph (Dionex 100) was employed to determine concentrations of anions of the caustic soda scrubber solution. These anionic standards were used to estimate the concentration of acid gases in the reference spectra and the calibration of the apparatus and measurement technique for the acidic species in the sample FTIR spectrum for the work described below.

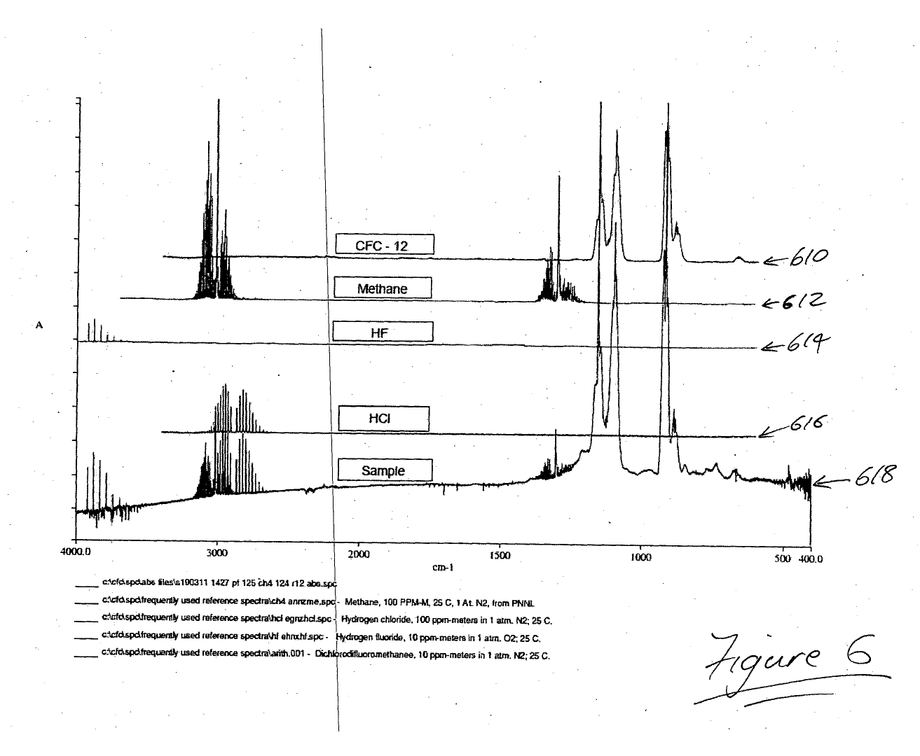

FIG. 6 is an example FTIR gas phase spectrum for a fluorocarbon, CFC-12, processed with methane as described below with respect to the fluorocarbon work. The optimized and customized FTIR apparatus and method used for this work had exceptional resolution and dynamic range as may be seen from FIG. 6. The positive controls of CFC-12 610 (reactant), methane 612 (reactant), HF 614 (gas phase product), HCl 616 (gas phase product) are over-laid with the gas phase sample product 618.

Carbon containing feed and product gas species were assayed by an in line micro-GC gas chromatograph (Varian CP-4900) 256 using thermal conductivity detectors. This micro-GC was equipped with a molecular sieve 5A and PoraPLOT Q columns. For identification of gaseous species, another gas chromatograph GC-MS (Shimadzu QP5000) 256 equipped with AT-Q column was used. For calibration, standard gases (Matheson Tri-Gas Inc.) were used where possible and relative molar response (RMR) factors (available in literature for many species or calculated from published correlations) were used for the remaining species.

For assaying of hydrogen, another gas chromatograph (Shimadzu GC-17A) 256, equipped with a molecular sieve 13X column and a thermal conductivity detector was used. A standard gas (Matheson Tri-Gas Inc.) was used to calibrate this gas chromatograph.

### Plasma Power Supply and Power Measurement.

The power supply 210 for the non thermal plasma 116 was a custom made (indigenous) of a variable voltage resonant convertor topology. The power supply delivered a sinusoidal output at a frequency of approximately 20 kHz or in the approximate range of 19 to 23 kHz or more preferably approximately 21.5 kHz. The voltage output was variable and controllable up to approximately 20 kV with a power capacity of up to approximately 20 W to the non thermal plasma reactor apparatus 110. A non-thermal plasma with a carrier gas of argon may be established at approximately 5 kV for the thermal plasma reactor apparatus 110 described here.

FIG. 3 is a circuit diagram of the circuit 310 used for averaged power measurement by the oscilloscope 216. Power measurement was made by the use of voltage-charge cyclograms, which also may be termed as Lissajous figures, as described by T. C Manley in “The Electric Characteristics of the Ozonator Discharge” Transactions of the Electrochemical Society 84 (1943) 83-96, the contents of which are incorporated herein by way of reference. A first capacitor C1 312 of approximately 3.17 pF capacitance is in series with a second capacitor C2 314 of approximately 10 nF capacitance to form a capacitive high voltage divider (3450:1) to the high voltage connection 140. The first capacitor may be selected by a person skilled in the art as being suitable for high voltage use at the frequencies required. The first and second capacitors 312, 314 were located within the power supply 210 together with the high voltage power generator 316. The oscilloscope 216 may be configured for X-Y operation and then the Y input 318 of the oscilloscope 216 connected across the second capacitor C2 314 via the voltage input line 219 to the oscilloscope (connection not shown in FIG. 2). The current integrating capacitor C3 214 of FIG. 2 may have a capacitance value of 3.3 nF. The current integrating capacitor may then be connected across the X input 320 of the oscilloscope 216 via the oscilloscope 216 current monitoring input 220.

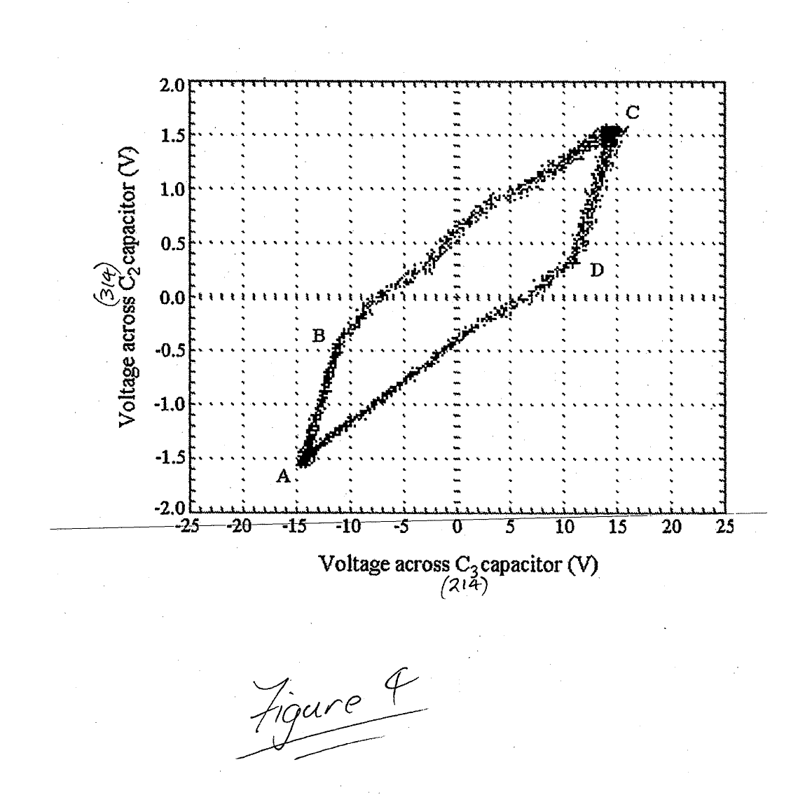

FIG. 4 is a copy of the oscilloscope 216 display/graph for a Lissajous figure. The conditions for the FIG. 4 Lissajous figure were: quartz dielectric tubes 126, 128, a gas stream 114 flow-rate of 100 cm³/min, a methane only concentration of 2.5% in an argon carrier gas and a 11 kV (pk-pk) applied voltage to the plasma reactor. The XY input channels were at Vx=5 V/div and Vy=0.5 V/div.

In the method of Manley the area of the Lissajous figure may be calculated by assuming a regular parallelogram with vertices A, B, C and D as shown in FIG. 4. The area obtained may then be used to calculate average power using the technique of Manley. However in practice the Lissajous figures approximate a regular parallelogram such that an integration of the Lissajous figures obtained for power measurement was done here to improve the power measurement accuracy.

The integration of the Lissajous figures done here was as follows. The voltage developed across capacitor C₃ 214, in series with the reactor load (approximately including the non-thermal plasma 116, the dielectric tubes 126, 128 and electrodes 136, 138), represents the time sum of displaced charge per half applied sinusoidal cycle. The oscilloscope 216 is configured for X-Y operation, charge indication (i.e. C₃ voltage 214) is assigned to the X-axis and applied voltage (i.e. C₂ voltage 314) to the Y axis. If the abscissa voltage per division of the oscilloscope grid is Vₓ, then actual charge corresponding to each horizontal division is C₃Vₓ. If V_{y} is the ordinate voltage per division of the oscilloscope, graph/display, then actual voltage corresponding to each vertical division of that graph is {(C₁+C₂)/C₁}V_{y}.

If the frequency of the applied sinusoid is f then the average power (in Watts) per square division of an oscilloscope grid/display is:

$$P = ( \frac{{C}_{3} ( {C}_{1} + {C}_{2} )}{{C}_{1}} ) ( {V}_{x} {V}_{y} ) f$$

A Lissajous figure area may then be determined by comparison of the weights of paper cut-outs of Lissajous figures against the weight of a single square reference grid cut-out. Alternatively the Lissajous figure may be integrated using graphical software methods. The Lissajous figure area thus obtained may then be converted to power via the above expression.

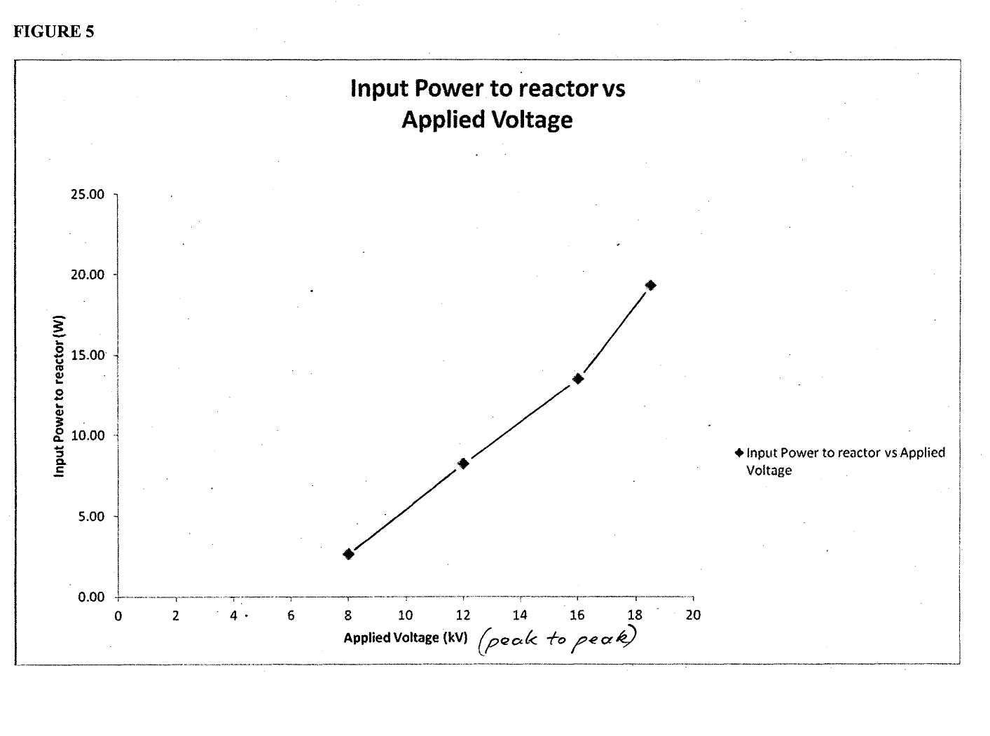

FIG. 5 is a graph of input power to the non-thermal plasma reactor 110 versus the applied voltage to the electrodes 136, 138. The input power was measured and calculated as described above. FIG. 5 corresponds to the reactor operation for the DCE experiments described below. In the fluorocarbon work described below, it was found that the presence of a halogenated compound influenced the values of an input power versus applied voltage graph but the general trend was similar to that observed for the DCE work of FIG. 5.

The apparatus described above and further below for providing the means for the non-thermal plasma reaction zone 116 and generating the non-thermal plasma may also be broadly described as a “Dielectric Barrier Discharge” (DBD) technique and apparatus as generally understood and practiced by those skilled in the art.

### Polymer Recovery and Characterisation

The polymer from the fluorocarbon experiments was usually deposited as a solid film upon the walls of the annular space 130 between the dielectric tubes 126, 128. The polymer was recovered from walls of the tubes by dissolving the polymer in tetrahydrofuran solvent (99.9% purity). The recovery of the polymer was very high as confirmed by the overall mass balances; an example of such is given below at TABLE 4 for CFC-12 and TABLE 5 for the DCE work. The dissolved polymer was then precipitated with methanol (99.9% purity) for NMR and gel permeation chromatography (GPC) analyses.

One dimensional and two dimensional NMR analysis was performed upon the polymer with a Bruker Avance 400 MHz spectrometer. The polymer for NMR analysis was dissolved in deuterated chloroform (CDCl₃) with 0.03% v/v tetramethylsilane (TMS).

A gel permeation chromatograph (GPC) (Shimadzu, Prominence) was used to measure the molecular weight of the polymers. The GPC was equipped with refractive index (RI) detector and two Styragel columns (HR5E and HR3) operating at 40° C. Linear polystyrene standards (Shodex) in the molecular weight range of 530 to 505 000 g/mol (Mₙ) were used for calibration. Data were analyzed by Shimadzu LCSolution 10A software. The polymer was dissolved in tetrahydrofuran (THF) for GPC analysis.

Elemental analysis of the polymer was performed at the Australian National University (ANU). An automatic analyser Carlo Erba 1106 was used for C, H, N elemental analysis. A Dionex Ion Chromatography Analyser was used for the halogens elemental analysis.

### Fluorocarbon Results

A range of fluorocarbons were processed through the non-thermal reactor with methane (99.95% purity) as an alkane gas and argon (99.999% purity) as the carrier gas. These fluorocarbons were:
CFC-12 (CCl₂F₂ purity 99.8%)
CFC-11 (CCl₃F purity >99%)
HCFC-22 (CHClF₂ >98%)
HFC-23 (CHF₃ >98%)
Halon 1301 (CBrF₃ 98.5%)
Halon 1211 (CBrClF₂ 98.7%)
FC-3-1-10 (C₄F₁₀ >98%)
CFC-Mix of: 96% CFC-12, 3.3% HFC-134A & 0.4% HCFC-22 (a refrigerant mixture recovered in Australia)

Unless otherwise indicated the process conditions were: a gas stream volumetric flow rate of approximately 100 cm³/min, the gas stream 114, 118 at approximately atmospheric pressure, a process time of approximately 90 minutes, concentrations in the carrier gas of approximately 1.25% for both the methane and the fluorocarbon (the balance being argon). An average residence time for the gas stream 114, 118 and consequently the reactants in the non-thermal plasma reaction zone 116 was approximately three seconds or more preferably 2.95 seconds. All the fluorocarbons tested are gases at room temperature, except for CFC-11 which was heated to vaporize it for processing in the invention/s. The applied voltages given below were each optimized for each fluorocarbon in terms of the percentage conversion. The percent conversion for methane is defined as:

$$\% conversion of {CH}_{4} = \frac{moles of {CH}_{4} consumed}{moles of {CH}_{4} introduced} \times 100$$

Similarly for the percentage conversion for a fluorocarbon.

Optionally the applied voltages may be also slightly higher than the respective breakdown voltages (or potentials) for each fluorocarbon and methane mixture.

TABLE 1A below provides results to the percentage conversion of the fluorocarbon and methane reactants. The optimal applied voltage for the non-thermal plasma was often different between each fluorocarbon mixture. The percentage conversion for each reactant may also vary between each fluorocarbon. It may be expected that longer residence times for the reactants in the plasma reaction zone may increase the percentage conversions. For example longer residence times may be obtained by lengthening the non-thermal plasma reaction zone 116

TABLE 1A

| | Applied Voltage | % Conversion, | % Conversion, |
|---|---|---|---|
| Fluorocarbon feed | (kV, peak-peak) | Fluorocarbon | Methane |
| CCl₂F₂ (CFC-12) | 13.5 | 59 | 56 |
| CCl₃F (CFC-11) | 16.0 | 38 | 40 |
| CHClF₂ (HCFC-22) | 13.5 | 68 | 68 |
| CHF₃ (HFC-23) | 12.5 | 48 | 72 |
| C₄F₁₀ (FC-3-1-10) | 16.0 | 21 | 48 |
| CBrCIF₂ | 14.0 | 41 | 27 |
| (Halon 1211) | | | |
| CBrF₃ (Halon1301) | 13.5 | 34 | 35 |

In separate experiments the concentration of the reactants CFC-12 with methane were varied. The percentage conversions of CFC-12 and methane are given in TABLES 1B and 1C below. In TABLE 1B the concentrations for CFC-12 and methane were both increased by the same amounts. Without wishing to be bound by theory, for a constant applied voltage and power input to the non-thermal plasma there may be no substantial change in formation and quantity of metastable argon atoms in the plasma. Accordingly the breakdown of reactant molecules by metastable argon atoms and by electron impact reactions may not increase proportionally with the reactant concentration changes, consequently the percentage conversion for each reactant may drop as observed in TABLE 1B.

TABLE 1B
Conversion of reactants with reactant concentration joint variation at an
applied voltage to the non-thermal plasma of 13.5 kV (pk-pk).

| | | % Conversion, | % Conversion, |
|---|---|---|---|
| Conditions | | CFC-12 | CH₄ |
| 1) | 0.75% CFC-12, 0.75% CH₄, | 72 | 71 |
| | 100 cc/min feed rate | | |
| 2) | 1.25% CFC-12, 1.25% CH₄, | 57 | 54 |
| | 100 cc/min feed rate | | |
| 3) | 1.75% CFC-12, 1.75% CH₄, | 48 | 45 |
| | 100 cc/min feed rate | | |

In TABLE 1C the concentration of CFC-12 in the inert carrier gas has been kept constant at 1.25% whilst the methane concentration has been varied from 0.75% to 1.75%. It may be seen in TABLE 1C that the percentage conversion of CFC-12 increases with alkane gas (methane) concentration whilst the reactant concentration of CFC-12 to the non-thermal plasma reactor has remained constant. Without wishing to be bound by theory, the recombination rate of molecular fragments of CFC-12 may decrease with the increase in molecular fragments in the plasma from the comparatively increased concentrations of methane (despite a reduction in percentage conversion of methane). Accordingly the percentage conversion of CFC-12 increases with the concentration increases of methane in the carrier gas. As per TABLE 1B the percentage conversion of methane decreases with increasing concentration of the methane in the carrier gas.

TABLE 1C
Conversion of reactants with variation of methane concentration only at
an applied voltage to the non-thermal plasma of 13.5 kV (pk-pk).

| | | % Conversion, | % Conversion, |
|---|---|---|---|
| Conditions | | CFC-12 | CH₄ |
| 1) | 1.25% CFC-12, 0.75% CH₄, | 54 | 64 |
| | 100 cc/min feed rate | | |
| 2) | 1.25% CFC-12, 1.25% CH₄, | 57 | 54 |
| | 100 cc/min feed rate | | |
| 3) | 1.25% CFC-12, 1.75% CH₄, | 63 | 52 |
| | 100 cc/min feed rate | | |

The halogenated compound and/or the alkane gas may be at a concentration in the gas stream of less than approximately 2% and be sufficiently converted in the non-thermal plasma to produce the polymer.

The surprising property of the polymer being readily and completely (or substantially so) dissolved in the tetrahydrofuran solvent is a strong indicator of the formation of predominantly non cross-linked polymers. In contrast polymers synthesized from plasma processes of other workers are typically cross-linked and consequently have poor solubility and/or are insoluble in organic solvents. Non cross-linked polymers have several advantages over cross-linked polymers, for example their high solubility in common solvents allows non cross-linked polymers to be considerably more easily purified and categorized, e.g. molecular weight measurements. In applications involving the use of non cross-linked polymers they may be reshaped by heating which is an advantage when working polymers.

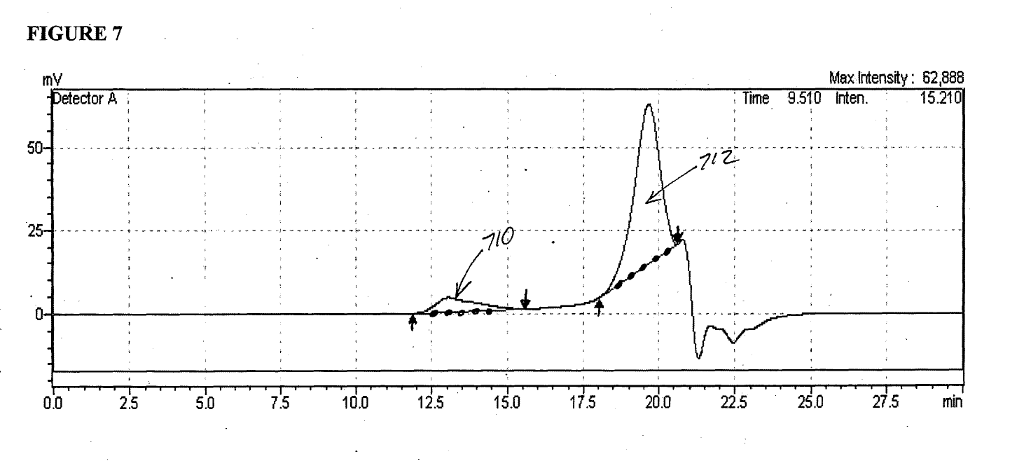

FIG. 7 is a gel permeation chromatography (GPC) trace of a polymer derived from CFC-12 and methane, dissolved in tetrahydrofuran solvent. FIG. 7 clearly shows two fractions, a high molecular weight fraction 710 and a low molecular weight fraction 712. The two molecular weight fractions were present for all the fluorocarbons processed with methane as listed above. For all the fluorocarbons the low molecular weight fraction 712 had a number averaged molecular weight (Mₙ) in an approximate range of 500 to 2500 g/mol. The low molecular weight fraction 712 may be oligomers of the macromolecules of the high molecular weight polymer fraction 710.

TABLE 2 below provides individual results to the higher molecular weight fraction 710 for the polymer product for the fluorocarbons tested. The higher molecular weight values in TABLE 2 are given as two values, Mₙ and M_{w}. Mₙ is the number average molecular weight. M_{w} is the weight average molecular weight. The peak molecular weight (Mₚ) for CFC-12 was 121,000 g/mol. The polymer products were favourable to a uniform molecular weight distribution range such that an excellent Polydispersity Index was obtained.

TABLE 2

| | | | Molecular | |
|---|---|---|---|---|
| | | | Weights (g/mol, | |
| | Applied | | with respect to | |
| | Voltage | | polystyrene | |
| | (kV, peak- | Major Gas Phase | standards) | |
| Reactants | peak) | Products | Mn | Mw |
| 1.25% CCl₂F₂ | 13.5 | CH₃Cl, C₂HClF₄, | 79,300 | 154,000 |
| (CFC-12) | | CH₂Cl₂, C₂H₂Cl₂F₂, | | |
| and 1.25% | | CHCl₃, HF and HCl | | |
| CH₄ in Ar | | | | |
| 1.25% CCl₃F | 16.0 | CH₃Cl, CHCl₂F, | 58,400 | 158,700 |
| and 1.25% CH₄ | | CH₂Cl₂, CHCl₃, HF | | |
| in Ar | | and HCl | | |
| 1.25% CHClF₂ | 13.5 | CHF₃, C₂H₂F₄, | 127,400 | 152,700 |
| and 1.25% CH₄ | | CH₃Cl, CCl₂F₂, | | |
| in Ar | | CH₂ClF, C₂HClF₄, | | |
| | | HF and HCl | | |
| 1.25% CHF₃ and | 12.5 | C₂H₂, C₂H₆, C₂H₃F, | 114,500 | 142,100 |
| 1.25% CH₄ in Ar | | C₂H₂F₄, C₃H₈ and | | |
| | | HF | | |
| 1.25% CFC-Mix | 14.0 | CH₃Cl, CH₂ClF, | 89,600 | 152,200 |
| and 1.25% CH₄ | | C₂HClF₄, CH₂Cl_{2,} | | |
| in Ar | | C₂H₂Cl₂F₂, CHCl₃, | | |
| | | HF and HCl | | |
| 1.25% CBrF₃ and | 13.5 | CHF₃, C₂H₂F₂, | 67,100 | 158,900 |
| 1.25% CH₄ in Ar | | CH₃Br, CBr₂F₂, | | |
| | | C₂Br₂F₄, HF and | | |
| | | HBr | | |
| 1.25% CBrCIF₂ | 14.0 | CH₃Cl, CH₃Br, | 56,500 | 167,800 |
| and 1.25% CH₄ | | CBr₂F₂, HF, HCl | | |
| in Ar | | and HBr | | |
| 1.25% C₄F₁₀ and | 16.0 | CHF₃, C₂H₂, | 68,200 | 151,700 |
| 1.25% CH₄ in Ar | | C₂H₂F₂, C₂H₆, | | |
| | | C₂H₃F and HF | | |

The ratio of M_{w}/Mₙ is often termed the Polydispersity Index (PDI) or molar-mass dispersity. PDI is a measure of the degree of heterogeneity of macromolecular species in a polymer blend. PDI=1 corresponds to a uniform polymer of one macromolecular species. PDI=600 would be a highly heterogeneous polymer blend with a large number of macromolecular species. TABLE 3 below provides the corresponding PDI value for the high molecular weight fraction 710 polymers produced from each fluorocarbon processed. The PDI are in general very low between the approximate range of 1.0 to 2 indicating that highly uniform polymers may have been produced.

TABLE 3

| | Applied Voltage | Polydispersity |
|---|---|---|
| Reactants | (kV, peak-peak) | Index (PDI) |
| CCl₂F₂ (CFC-12) and CH₄ | 13.5 | 2.0 |
| CCl₃F and CH₄ | 16.0 | 2.7 |
| CHClF₂ and CH₄ | 13.5 | 1.2 |
| CHF₃ and CH₄ | 12.5 | 1.2 |
| C₄F₁₀ and CH₄ | 16.0 | 2.2 |
| CBrCIF ₂ and CH₄ | 14.0 | 2.9 |
| CBrF₃ and CH₄ | 13.5 | 2.4 |
| CFC-Mix and CH₄ | 14.0 | 1.7 |

TABLE 2 also provides results to the major gas phase products for the fluorocarbons tested together with methane and argon. From TABLE 2 it is apparent that F₂ and Cl₂ are absent or substantially absent from all the gas phase products. The absence of F₂ and Cl₂ is a consequence of the absence of oxygen in the gas stream and the non-thermal plasma reaction zone. In this work the acid gases HF and HCl are present instead which considerably facilitates the removal of fluorine and chlorine from the product/exposed gas stream 118 compared with a process and/or apparatus which produces F₂ and/or Cl₂. In addition the presence of acid gases HF and HCl in the gas phase products compared with F₂ and Cl₂ may provide a considerably safer process and apparatus. A non-oxidative environment prevents reactions such as 2HCl+½O₂->Cl₂+H₂O and/or 2HF+½O₂->F₂+H₂O occurring for the formation F₂ and Cl₂. The use of an alkane gas such as methane (CH₄) provides molecular fragments including atomic hydrogen. Molecular fragments from methane reduce the recombination rates of molecular fragments from CCl₂F₂, assist in the conversion of CCl₂F₂ and consequently the production of HF and HCl instead of F₂ and Cl₂. Molecular fragments derived from CCl₂F₂ may be absent in atomic H or in a very low stoichiometric proportion. In other words if the non-thermal plasma reaction zone is “starved” of hydrogen then undesirable halogen gases such as F₂ and Cl₂ will form.

TABLE 4 provides detailed elemental mass balances for the processing of CFC-12 with methane at an applied voltage of 13.5 kV to the non-thermal plasma. It can be seen in TABLE 4 that the individual element mass balances and the overall mass balance are excellent, an indicator of good experimental technique. In the gas phase products section of TABLE 4 a column is given to the reactant CFC-12 portion which did not react in the non-thermal plasma reaction zone, viz. 242.70 mg. That is the portion of the feed reactant CFC-12 which was not converted.

In TABLE 4 it may also be seen that the proportion of HF acid in the gas phase products is very low at approximately 4.4%. In contrast existing technologies which convert fluorocarbons to acids and CO₂ often have a gas phase product concentration for HF which may be very high, up to 10%. It is an advantage to be able to minimize the level of highly corrosive and dangerous HF as a gas phase product to less than 4.4%.

In the CFC-12 experiment of TABLE 4, approximately 58% w/w of the converted fluorine is incorporated into the polymer. 710 and oligomers 712. That it is up to 58% of the fluorine from converted reactant such as CFC-12 (CCl₂F₂) is portioned to and/or bound into the polymer 710 and oligomers 712. Similarly approximately up to 41% of the chlorine from a converted reactant such as CFC-12 (CCl₂F₂) is portioned to and/or bound into the polymer 710 and oligomers 712. It was observed for all the fluorocarbons tested that the majority and/or a large proportion of the converted halogens were incorporated into the polymer product. The elemental composition of the polymer derived from CFC-12 and methane was:

Carbon: 27.5%

Hydrogen: 1.8%

Fluorine: 25.9%

Chlorine: 44.8%

TABLE 4

| | Feed (mg) | | Products, Gas (mg) | | | | | | | | | | |
|---|---|---|---|---|---|---|---|---|---|---|---|---|---|
| | CH₄ | CFC-12 | CH₄ | CH₃Cl | CFC-12 | C₂HClF₄ | CH₂Cl₂ | C₂H₂Cl₂F₂ | CHCl₃ | H₂ | HF | HCl | Others |
| C-balance | 60.88 | 58.92 | 27.01 | 0.62 | 24.08 | 1.18 | 0.51 | 0.99 | 0.39 | 0.00 | 0.00 | 0.00 | 7.20 |
| H-balance | 20.29 | 0.00 | 9.00 | 0.15 | 0.00 | 0.05 | 0.09 | 0.08 | 0.03 | 2.47 | 0.47 | 2.89 | 0.42 |
| F-balance | 0.00 | 186.59 | 0.00 | 0.00 | 76.26 | 3.74 | 0.00 | 1.57 | 0.00 | 0.00 | 16.0 | 0.00 | 21.54 |
| Cl-balance | 0.00 | 348.62 | 0.00 | 1.82 | 142.49 | 1.75 | 3.04 | 2.93 | 3.50 | 0.00 | 0.00 | 102.65 | 9.89 |
| Overall- | 81.17 | 594.13 | 36.01 | 2.59 | 242.70 | 6.72 | 3.64 | 5.57 | 3.93 | 2.47 | 9.36 | 105.55 | 39.21 |
| balance | | | | | | | | | | | | | |

| | Products, Solid | | | | |
|---|---|---|---|---|---|
| | Polymer & Oligomer (mg) | | | Total | Mass |
| | Inner tube | Outer tube | Total Mass In (mg) | Mass Out (mg) | balance, (%) |
| C-balance | 6.19 | 46.88 | 119.80 | 115.05 | 96.04 |
| H-balance | 0.41 | 3.10 | 20.29 | 19.15 | 94.40 |
| F-balance | 5.82 | 44.10 | 186.59 | 161.92 | 90.60 |
| Cl-balance | 10.11 | 76.54 | 348.62 | 354.72 | 101.75 |
| Overall- | 22.50 | 170.50 | 675.30 | 650.75 | 96.36 |
| balance | | | | | |

From TABLE 4 the total converted mass of product was 408.05 mg of which 193 mg was the polymer 710 and the oligomers 712. That is approximately 47% w/w of the converted product was polymer 710 and oligomers 712. The majority of the balance of the gas phase products is HCl at approximately 49% w/w. HCl is an industrially useful chemical which may be utilized by other industries.

It may be seen from TABLE 4 that 88% of the polymer product is deposited on the inner surface of the outer tube 128. The deposition of the polymer may be aided by the cooler outer tube 128 condensing the polymer and/or precursors and/or intermediate species from the non-thermal plasma. No forced cooling was applied to either of the dielectric tubes 126, 128 during the process. It may be expected then that the inner surface of the outer tube 128 will be relatively cooler than the outer surface of the inner tube 126.

The exposed gas stream 118, 122 gas temperature was in the approximate temperature range of 90° C. to 180° C. for all fluorocarbon processing here. The gas temperature varied depending on the composition of the input gas stream 114, the applied voltage to the non-thermal plasma and other related process parameters. The gas temperature 123 was measured as described with respect to FIG. 1A.

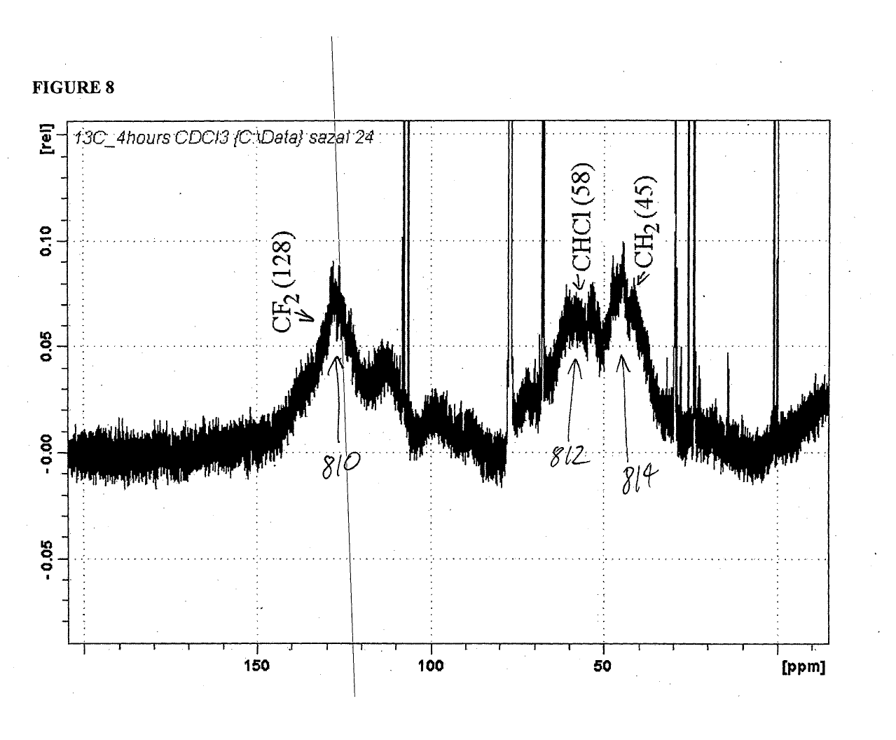

FIG. 8 is a one dimensional ¹³C NMR spectrum for a polymer derived from CFC-12 and methane as described above. The functional groups CF₂ 810, CHCl 812 and CH₂ 814 have been identified in the polymer as shown.

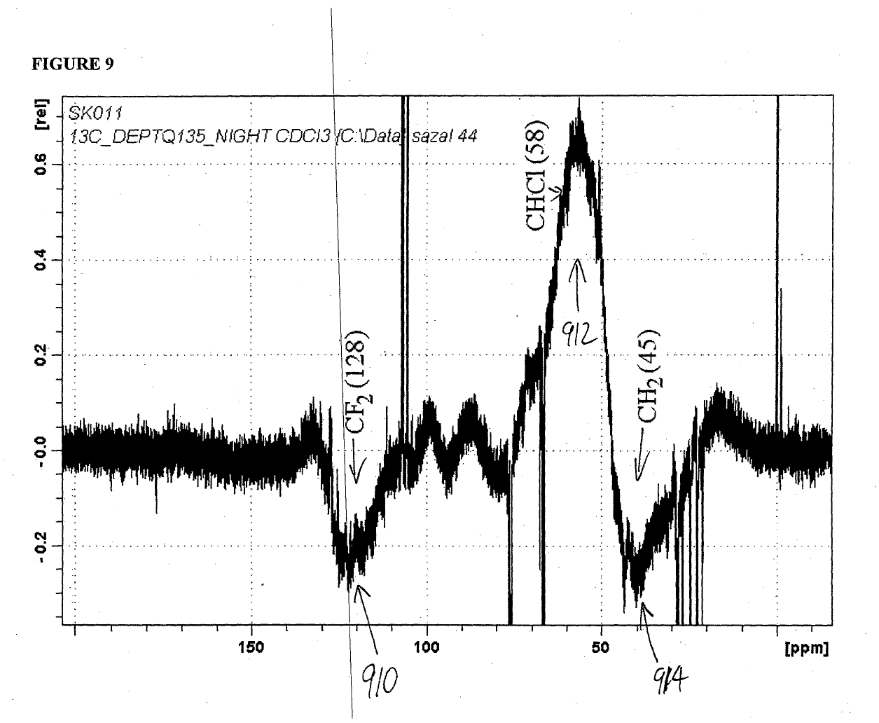

FIG. 9 is a one dimensional DEPTQ ¹³C NMR spectrum for a polymer derived from CFC-12 and methane. DEPTQ provides increased sensitivity to quarternary ¹³C functional groups. Again the functional groups CF₂ 910, CHCl 912 and CH₂ 914 were identified for the polymer.

The results in TABLE 2 together with the NMR analyses of FIGS. 8 and 9 may suggest that the formation of functional groups and their polymerization to the polymer products may be controlled by the applied voltage to the non-thermal plasma as well as other characteristics of the non-thermal plasma.

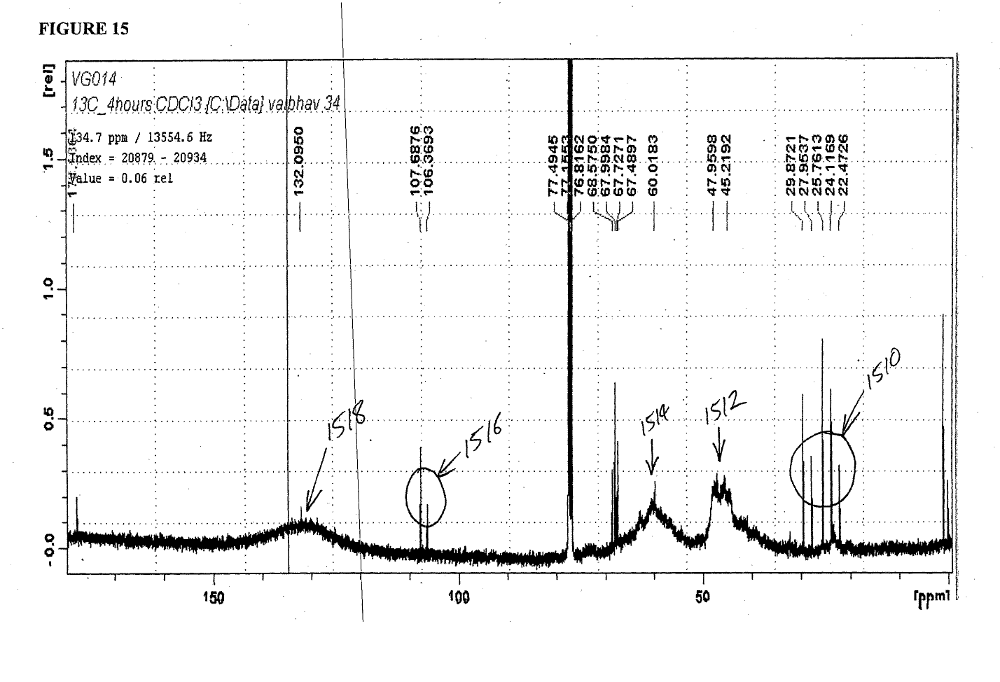

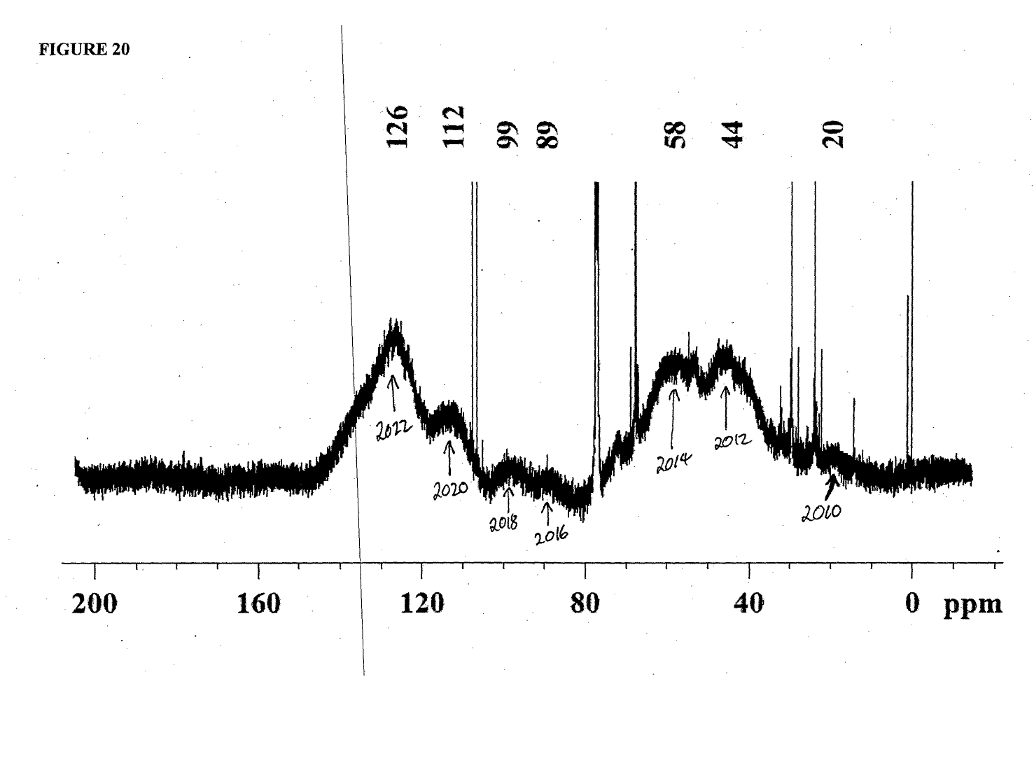

FIGS. 20 to 23 are further. NMR analysis spectra to the polymer from the processing of CFC-12 with methane (1.25% both reactant concentrations and an applied voltage of 13.5 kV pk-pk). Only the high molecular weight fraction was analyzed as per the other NMR analyses. The high molecular weight fraction/polymer peaks of interest are the broad peaks as described below with respect to FIG. 15. That is, the broad peaks are indicative of the main polymer structure, the high molecular weight polymer fraction. The sharp and comparatively narrow peaks are indicative of the oligomeric fraction.

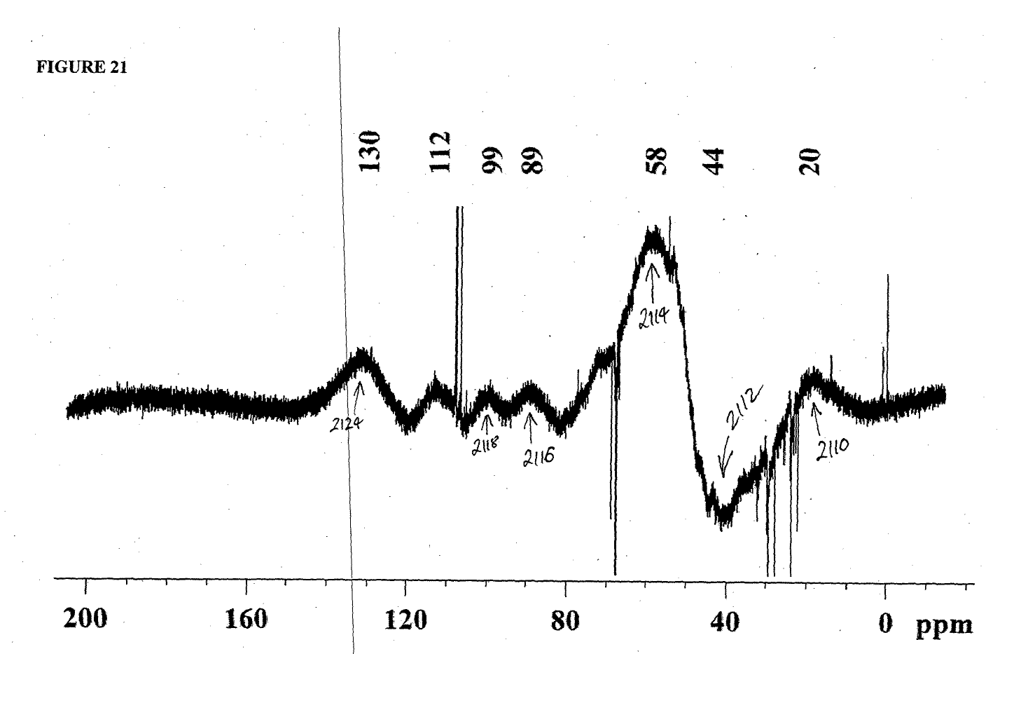

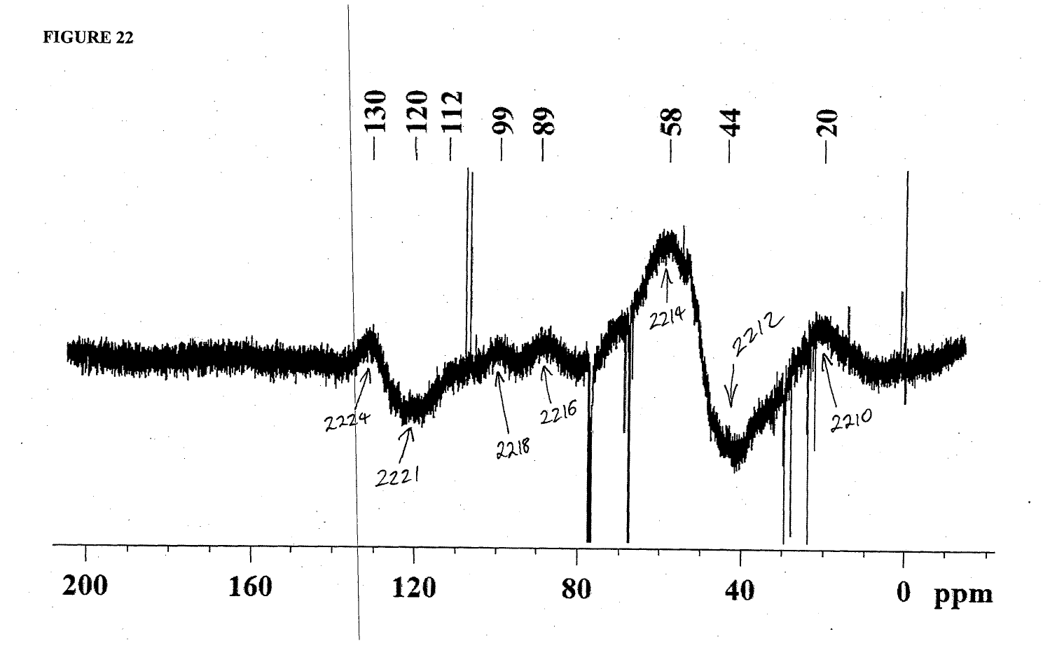

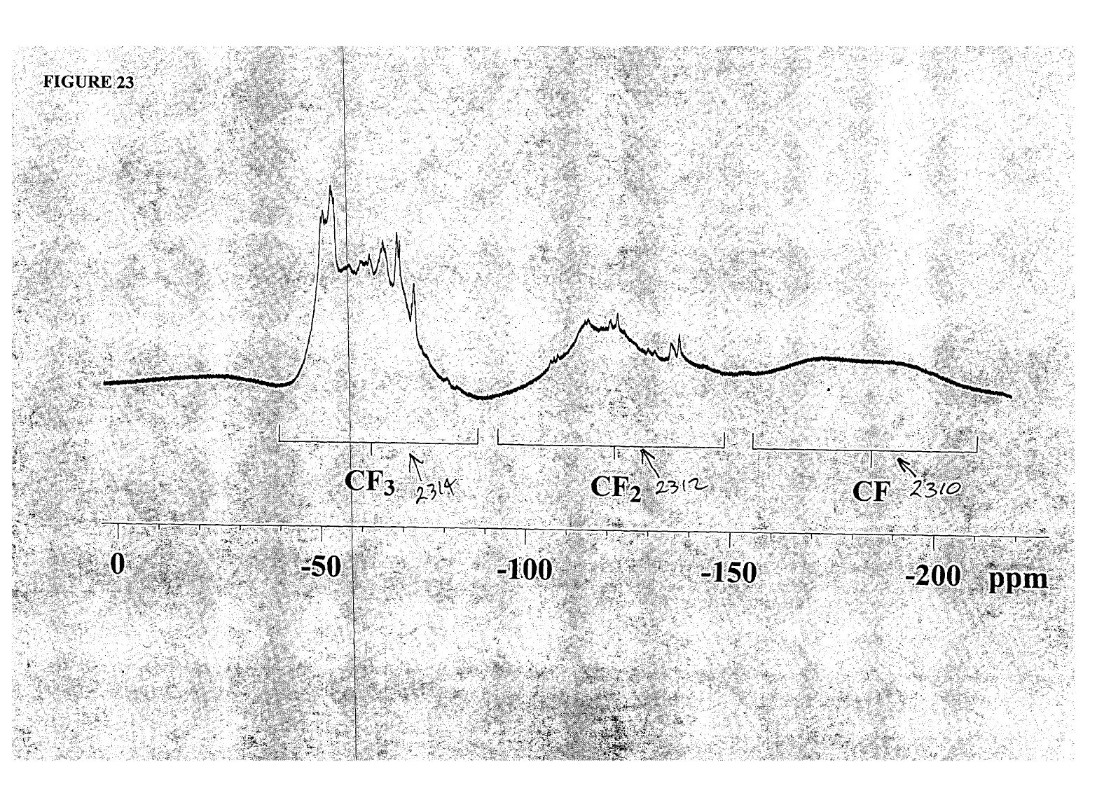

FIG. 20 is a ¹³C NMR spectrum which shows presence of several functional groups including CH₃, CH₂, CH, CHCl, CHF, CHClF and groups that have quaternary carbon. Quaternary carbon groups are carbon containing groups that do not have any hydrogen (e.g., CF₂). The ¹³C chemical shift at 20 ppm (item 2010) represents a CH₃ group. This peak is clearer in the DEPT 135 and DEPTQ 135 spectra of FIGS. 21 and 22 below. The ¹³C chemical shifts in FIG. 20 at 44 ppm (item 2012), 58 ppm (item 2014), 89 ppm (item 2016), 99 ppm (item 2018) and 112 ppm (item 2020) represent CH₂, CHCl, CHF, CHClF and CH groups respectively. The peak at 126 ppm (item 2022) in FIG. 20 includes groups of quaternary carbon and a CHF₂ group. The distinction of quaternary carbon and CHF₂ may be found in the DEPTQ 135 spectrum (shows as a CH peak) of FIG. 22. This quaternary carbon includes CF₂ and CF₃ as they are recognised in a ¹⁹F NMR spectrum of FIG. 23 below.

FIG. 21 is a DEPT 135 spectrum showing CH₃ and CH groups to one side of the horizontal axis of the spectrum and CH₂ to the other side. The spectrum does not show any group of quaternary carbon. In contrast, the DEPTQ 135 spectrum of FIG. 22 shows CH₃ and CH to one side of spectrum's horizontal axis and quaternary carbon and CH₂ to the other side. The DEPT and DEPTQ NMR spectra of FIGS. 21 and 22 assist in assigning peaks in the ¹³C NMR spectrum of FIG. 20.

The presence of CH₃ group at 20 ppm (items 2110, 2210) may be seen in both DEPT 135 and DEPTQ 135 spectra respectively of FIGS. 21 and 22. CH from CHCl, CHF, CHClF and CHF₂ may be found at 58 ppm (items 2114, 2214), 89 ppm (items 2116, 2216), 99 ppm (items 2118, 2218) and 130 ppm (items 2124, 2224) respectively of FIGS. 21 and 22. In the opposite side of the spectra's horizontal axis CH₂ peak is at 44 ppm (items 2112, 2212) in both DEPT 135 and DEPTQ 135 spectra of FIGS. 21 and 22 while quaternary carbon shows only in the DEPTQ 135 spectrum at 120 ppm (item 2221) of FIG. 22.

FIG. 23 is a ¹⁹F NMR spectrum of the polymer showing CF 2310, CF₂ 2312 and CF₃ 2314 peaks. The peaks in the approximate regions of −150 to −210 ppm (item 2310), −90 to −150 ppm (item 2312) and −50 to −90 ppm (item 2314), represent CF, CF₂ and CF₃ respectively. CF may be from CHF or CHClF group. CF₂ may be from end or branch group CHF₂ or may be from the polymer main chain, CF₃ peak is either end or branch group.

### DCE Results

DCE (1,2-dichloroethane) was processed through the non-thermal reactor with argon (99.999% purity) as the carrier gas. No alkane gas was added to the gas stream 114. In contrast to the fluorocarbon work, DCE (C₂ H₄Cl₂) is rich in atomic hydrogen and consequently does not require an alkane gas or hydrogen gas as an atomic hydrogen source for polymer formation.

Unless otherwise indicated the process conditions were: gas stream volumetric flow rate of approximately 200 cm³/min, gas stream 114, 118 at atmospheric pressure, a process time of approximately 63 minutes and a DCE concentration in the carrier gas of approximately 1.15% (the balance being argon). The average residence time for the gas stream and consequently the reactants in the non-thermal plasma reaction zone 116 was approximately 1.1 second or more preferably approximately 1.12 seconds.

The product/treated/exposed gas stream 118, 122 gas temperature for the DCE work was also as observed for the fluorocarbon work described above.

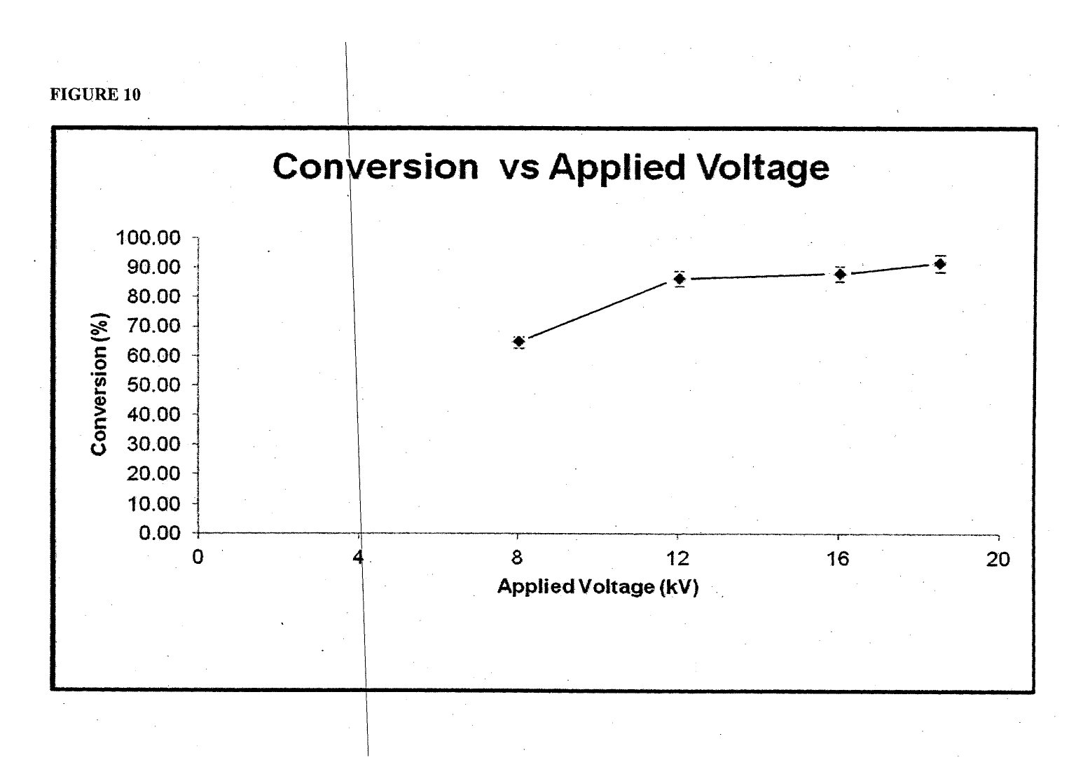

FIG. 10 is a graph of the percentage conversion of DCE in the non-thermal plasma 116 versus the applied voltage to the non-thermal plasma apparatus 110. The percentage conversion of DCE is defined as:

$$\% conversion of EDC = \frac{moles of DCE consumed}{moles of DCE introduced} \times 100$$

Error bars are shown on each data point in FIG. 10.

In FIG. 10 there is a general trend to increased conversion with increasing applied voltage which may be expected with increasingly energetic plasma. However a plateau in conversion from approximately 12 kV applied voltage becomes apparent.

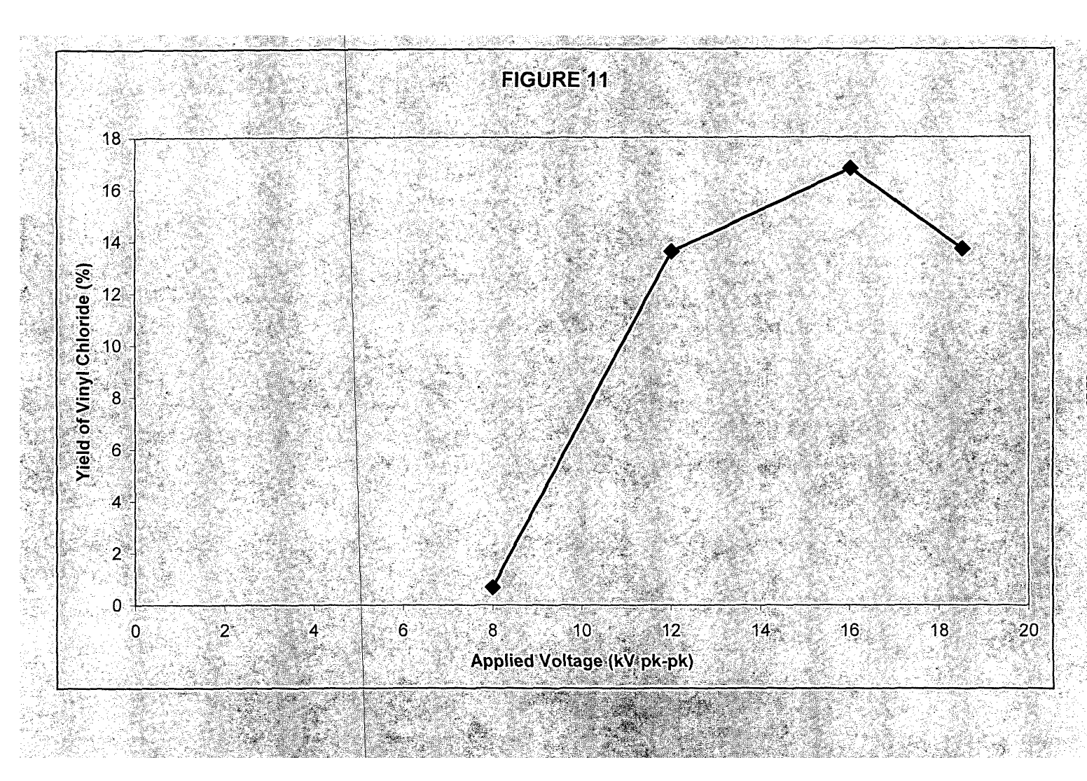

FIG. 11 is a graph of the yield of vinyl chloride (H₂C═CHCl) in the gas phase 118 from the non-thermal plasma 116 versus the applied voltage to the non-thermal plasma. The yield of vinyl chloride is defined as:

$$\% yield of {C}_{2} {H}_{3} Cl = \frac{moles of {C}_{2} {H}_{3} Cl formed}{moles of 1 , 2 DCE introduced} \times 100$$

It may be seen in FIG. 11 that there is a broad maximum yield at approximately 16 kV. At applied voltages higher than 16 kV it may be that the increased energy in the non-thermal plasma may result in appreciable decomposition of the vinyl chloride to acetylene (C₂H₂). It is to be noted that the original FIG. 10 on page 137 of the priority document of AU 2011903874 filed 21 Sep. 2011 is different to the present FIG. 11 in terms of the percentage yield values. This was due to a calculation error to the FIG. 10 in AU 2011903874 which is now corrected for present FIG. 11. It is to be noted that the overall trend expressed by both graphs is the same although the yield values are lower for the present FIG. 11.

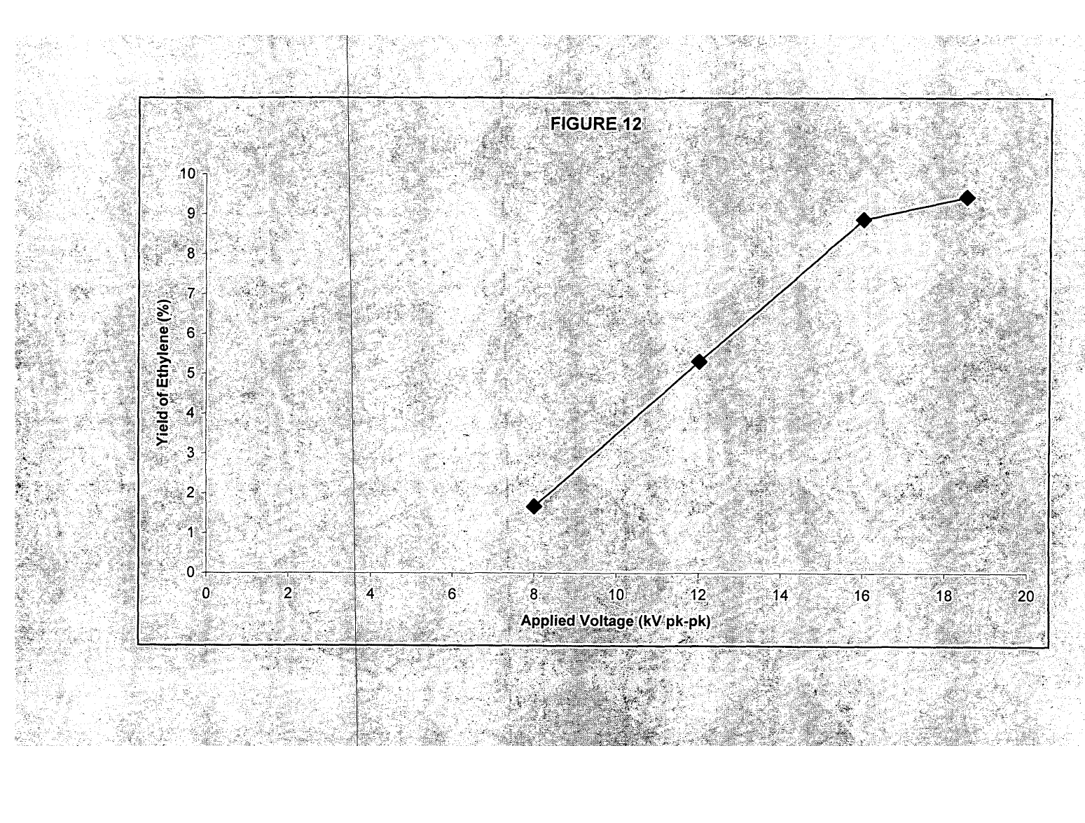

FIG. 12 is a graph of the yield of ethylene (H₂C═CH₂) in the gas phase 118 from the non-thermal plasma versus the applied voltage to the non-thermal plasma. The yield of ethylene is similarly defined as per vinyl chloride above. It is to be noted that the original FIG. 11 on page 138 of the priority document of AU 2011903874 filed 21 Sep. 2011 is different to the present FIG. 12 in terms of the percentage yield values. This was due to a calculation error to the FIG. 11 in AU 2011903874 which is now corrected for present FIG. 12. It is to be noted that the overall trend expressed by both graphs is the same although the yield values are lower for the present FIG. 12. In FIG. 12 the yield of ethylene increases with applied voltage.

TABLE 5 provides the mass balances for the DCE reactant, the gas phase products and the polymer/solid phase products for an applied voltage of 12 kV to the non-thermal plasma. As noted for TABLE 4 above the overall mass balance is again very good at 105%. In the gas phase products section of TABLE 5 a row is given to the reactant DCE portion which did not react in the non-thermal plasma zone, viz. 87.1 mg. That is, the portion of the feed reactant DCE which was not converted.

From TABLE 5, approximately 43% of the total product is polymer and oligomers. The gas phase products are dominated by HCl at approximately 43%, vinyl chloride at approximately 9.4% and then ethylene (ethene) at approximately 1.6%. Surprisingly toxic polychlorinated carbon compounds such as CCl₄, C₂Cl₄, CHCl₃ and C₂HCl₅ were all absent from the gas phase products. In an advantage over oxidative decomposition techniques for DCE, phosgene (COCl₂), and polychlorinated dibenzo-p-dioxins and polychlorinated dibenzofurans (PCDD/F) are absent from the products of the invention's non-oxidative, non-thermal plasma processing.

TABLE 5

| Mass (mg) | Species | |
|---|---|---|
| 640 | DCE | Feed |
| 0.450 | Methane | Products in gas phase |
| 9.62 (1.6% w/w) | Ethylene (ethene) | |
| 4.54 | Acetylene | |
| 0.24 | Ethane | |
| 54.9 | Vinyl Chloride | |
| 1.87 | Ethyl Chloride | |
| 0.675 | Dichloromethane | |
| 2.09 | 1,1-dichloroethylene | |
| 1.63 | trans 1,2-dichloroethylene | |
| 1.95 | 1,1-dichloroethane | |
| 2.36 | cis 1,2-dichloroethylene | |
| 87.1 | DCE (unreacted) | |
| 250 (43% w/w) | Hydrogen Chloride | |
| 2.55 | Hydrogen | |

| | |
|---|---|
| 252 (43% w/w) | Solid Products, Polymer (including Oligomers) |
| 640 | Mass In |
| 672 | Mass Out |

| | |
|---|---|
| 105 | Mass Balance (%) |

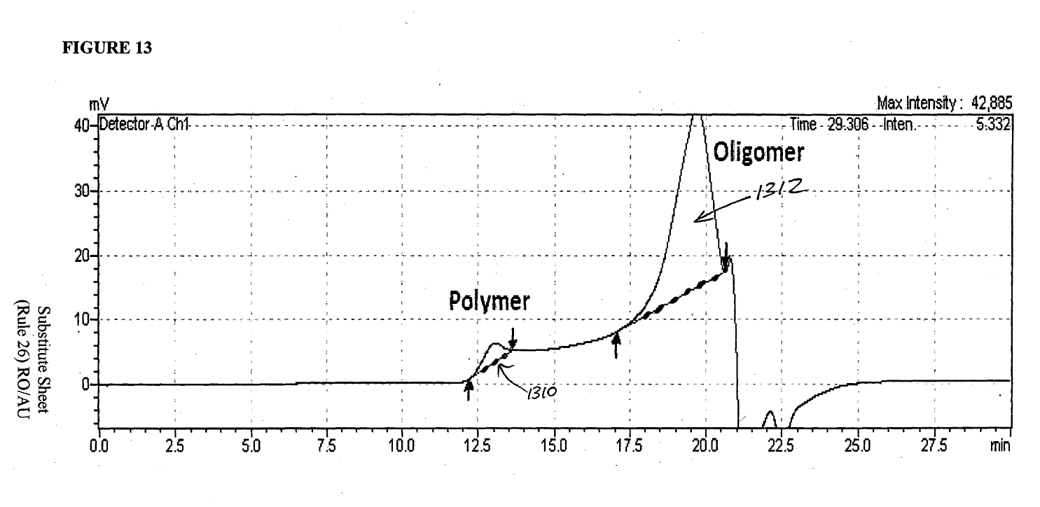

FIG. 13 is the GPC results for the solid products from DCE at an applied voltage of 12 kV to the non-thermal plasma. FIG. 13 clearly shows two fractions, a high molecular weight polymer fraction 1310 and a low molecular weight oligomer fraction 1312. The surprising property of the high molecular weight polymer fraction 1310 of also being readily and completely (or substantially so) dissolved in the tetrahydrofuran solvent was also observed for the DCE work here. The very high or complete solubility of the polymer 1310 in tetrahydrofuran is a strong indicator of the formation of predominantly non cross-linked polymers as also discussed above with respect to the fluorocarbon work.

When DCE was processed for 63 minutes, the peak molecular weights Mₚ were for the polymer fraction approximately 118,100 g/mol and for the oligomer fraction approximately 366 g/mol. When the DCE was processed for 95 minutes, again at the 12 kV applied voltage, the Mₚ for the polymer fraction was approximately 130,400 g/mol and for the oligomer fraction approximately 336 g/mol.

The number and weight average molecular weights for the polymer fraction 1310 were respectively approximately 129,000 g/mol and approximately 147,000 g/mol. The corresponding PDI was a very favourable 1.14 (approximately) indicating a highly uniform polymer faction and that a preferred PDI of approximately 1.1 may be obtained for the polymer 1310. The low molecular weight fraction 1312 had a number averaged molecular weight (Mₐ) in an approximate range of 610 to 800 g/mol. The corresponding weight average molecular weight (M_{w}) was in an approximate range of 900 to 1,100 g/mol. The low molecular weight fraction 1312 may be oligomers of the macromolecules of the high molecular weight polymer fraction 1310.

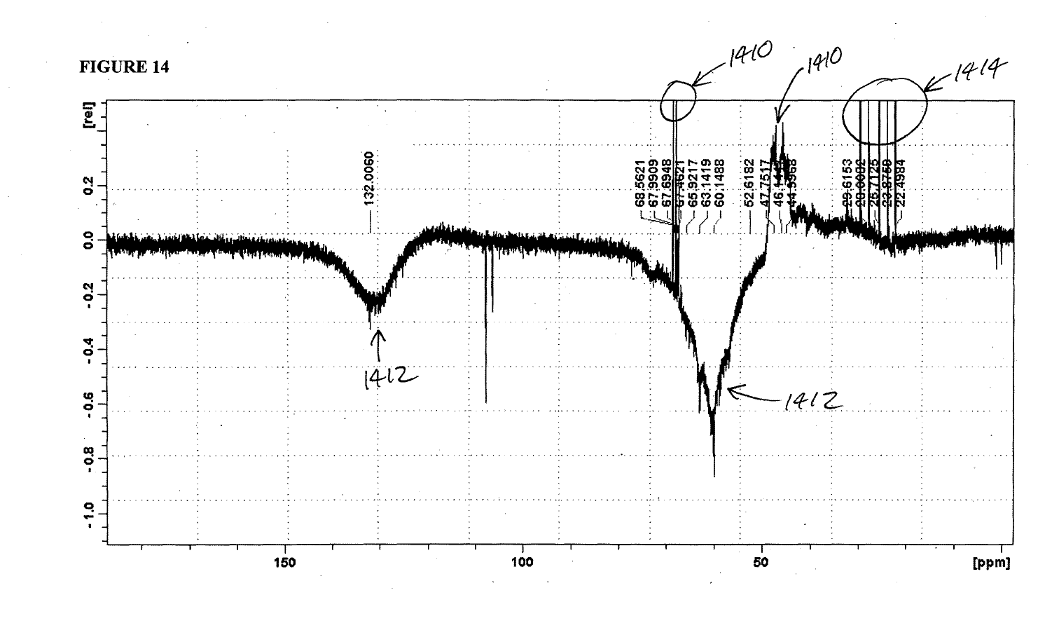

FIG. 14 is a one dimensional DEPT ¹³C NMR spectrum for the polymer derived from DCE for the applied voltage of 12 kV for the non-thermal plasma. The peaks 1410 in the region 44.9 to 47.8 ppm and 67.4 to 68.7 ppm were identified as the CH functional group 1410. The peaks 1412 in the region of 52 to 68 ppm and the broad peak around 130 ppm were identified as corresponding to the CH₂ functional group 1412. The narrow peaks 1414 between 22.4 and 29.7 ppm were identified as the CH₃ functional group 1414.

FIG. 15 is a one dimensional ¹³C NMR spectrum for the same polymer as FIG. 14. The ¹³C spectrum may be interpreted in light of the information from the DEPT spectrum. The broad peaks are indicative of the main polymer structure, the high molecular weight polymer fraction. The sharp and comparatively narrow peaks are indicative of the oligomeric fraction 1312. The narrow peaks 1510 in the region of approximately 22 to 27 ppm were identified as CH₂ functional groups with internal double bonds within the oligomeric fraction. The broad peak 1512 in the region of approximately 44.5 to 48 ppm was identified as CH₂ functional groups of the main polymer structure (high molecular weight fraction). The broad peak 1514 in the region of approximately 55 to 62 ppm was identified as the CHCl functional group of the polymer main chain in a repeating group. The narrow peaks 1516 in the region of approximately 106 to 108 ppm were identified as the CH functional group with a double bond in the oligomer fraction. The broad peak 1518 at about 131 ppm was identified as a CH functional group with an internal double bond in the polymer.

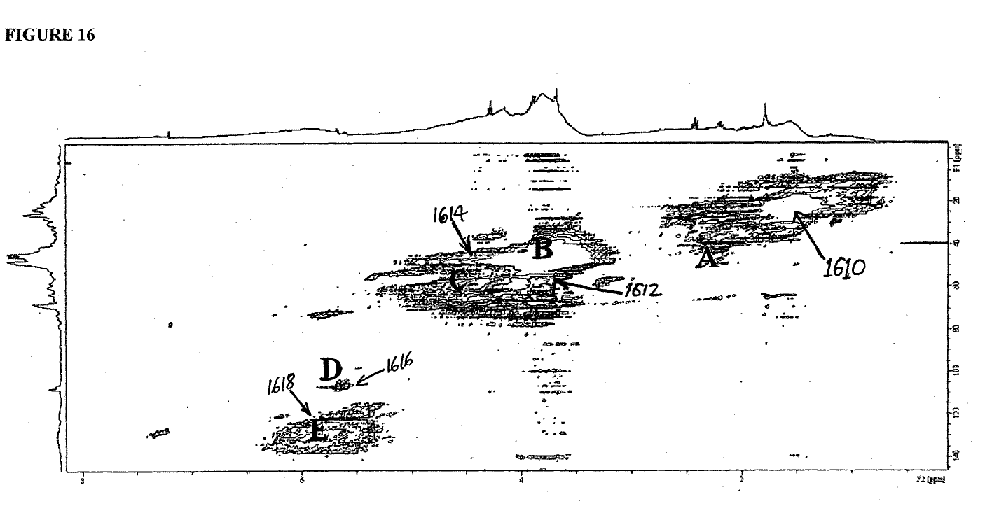

Two dimensional NMR measurements may be made to determine the various carbon and hydrogen couplings/functional groups. FIG. 16 is a two dimensional (2D) NMR spectrum of the polymer of the prior NMR FIGURES. A ¹H NMR spectrum is presented on the X-axis whilst the ¹³C NMR spectrum is presented on the Y-axis. The contours in the XY space may indicate the C—H correlation between the two spectra. The signal correlation at point A 1610 (about 1.3-1.5 ppm in H and about 24-27 ppm in ¹³C) was identified as a CH₃ terminal functional group principally from the oligomeric fraction. The correlation between signals at point B 1612 (about 3.7 to 3.9 ppm in H and about 55-68 ppm in ¹³C) were identified as a CH₂ group in a CH₂Cl functional group from within a CH₂CH₂Cl functional group. At point C 1614 (about 4.25 to 4.6 ppm in H and about 44.5 to 48 ppm in ¹³C) a CH group was identified in the CHCl repeating group in the main chain of the polymer. At Point D 1616 a CH₂ functional group with a double bond was identified for an end for an oligomer. At Point E 1618 a —CH₂ group was identified attached to a quaternary carbon atom of the polymer.

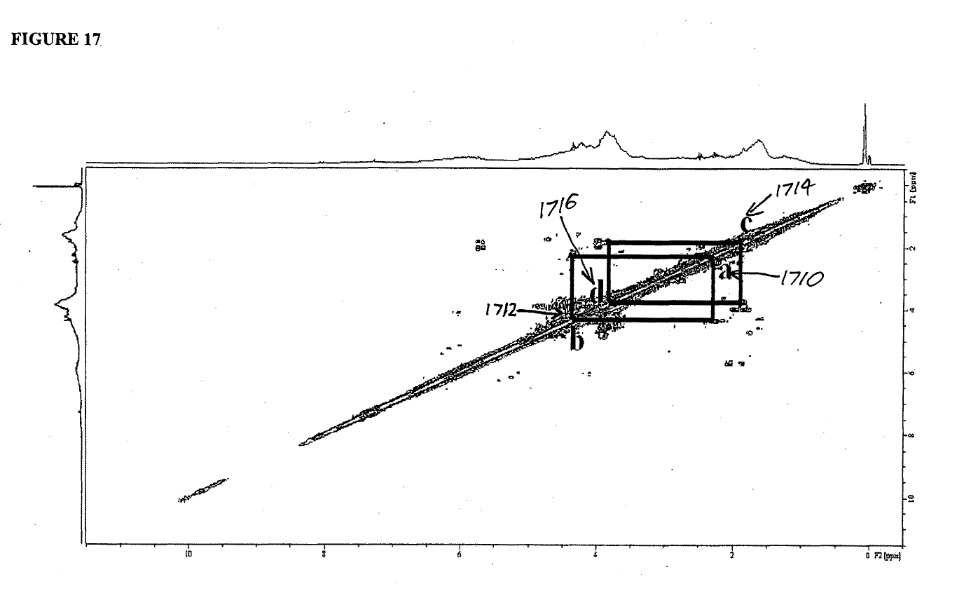

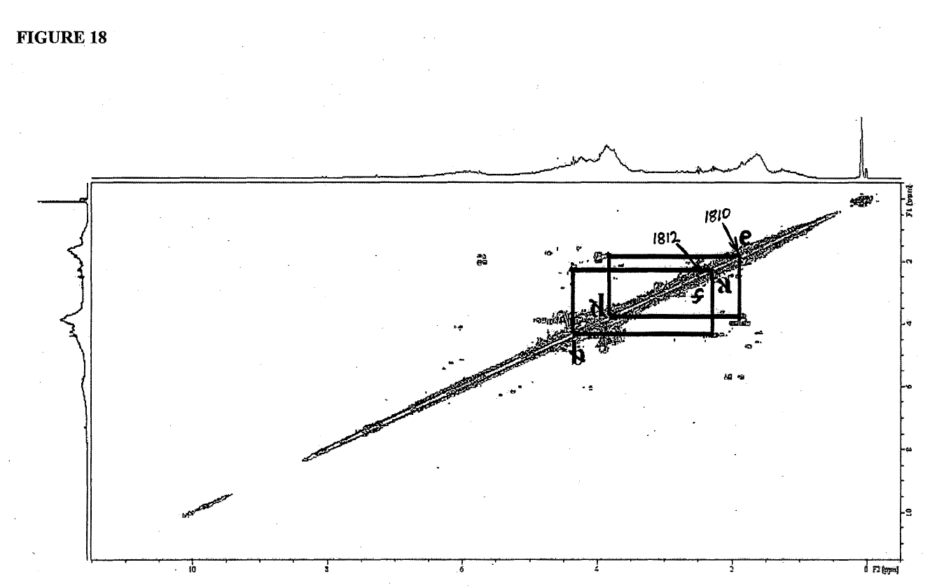

FIGS. 17 and 18 are two dimensional COSY NMR spectra of the polymer of the prior NMR FIGURES. FIGS. 17 and 18 have the same spectra on each axis. COSY 2D NMR plots may provide an analysis of the hydrogen-hydrogen correlation. In a COSY spectrum, off-diagonal (off the x=y line) peaks may indicate an H—H correlation.

In FIG. 17 the points “a” 1710 and “b” 1712 were identified as coupled protons from CH₂—CHCl repeating groups of the polymer main chain which may be a result of the polymerization of vinyl chloride. Points “c” 1714 and “d” 1716 may indicate coupling of protons in the polymer's main chain within a CH₂ of a CH₂Cl functional group.

In FIG. 18 points “e” 1810 and “f” 1812 may indicate coupling of CH₂—CH₂ protons within the main chain of the polymer. This may have arisen from the polymerization of ethylene.

### Alternate Embodiments

An alternate embodiment of the invention may be used to process solids. For example the plasma reactor apparatus 110 of FIG. 1A together with the apparatus and operation with respect to FIG. 2 may be re-configured and adapted for handling a solid feed of halogenated compounds or organic compounds. FIG. 19 is a schematic diagram of a vertical plasma reactor apparatus 1910 with a feed system for solids. An inlet manifold 1912 may have a screw feeder 1940 containing a fine particulate or powder feed 1942 of the solid feed compound/s. The solid compounds may be ground to a particle size less than the Stokes settling velocity in the gas stream 1914 to form the fine particulate/powder feed 1942. A gas stream supply 1944 supplies the gas stream 1914 to the inlet manifold 1912 and to the nozzle 1946 or other powder dispersal device for the screw feeder 1940. The gas stream supply 1944 may be generally adapted from that described above with respect to the description of FIG. 2.

The screw feeder 1940 may push out the fine particulate feed 1942 through the nozzle 1946 to be entrained into the gas stream 1914, 1915. The gas stream with the entrained fine particulates 1915, 1942 may then be presented to the vertical plasma reactor 1910 for similar processing to a polymer/s and other products as described for the gas and liquid feed embodiments above. The polymer product may be deposited on the surfaces of a deposition/condensing section 1920. The product/treated/exposed gas stream 1918 flows to processing 1948 of the product/exposed gas stream, which may be generally as described above with respect to FIG. 2 and elsewhere. The vertical arrangement of the apparatus 1910 alleviates issues with particle settling upon horizontal surfaces. The polymer deposition section 1920 may be also selected or otherwise designed so as to minimise the collection of any waste particulates by settling or inertial impact. Waste particulates may be collected in a trap 1950 designed to collect falling waste particulates.

To further aid in the dispersal of the fine particulate feed 1915, the powder may be suspended in a suitable liquid to form a suspension or slurry. The liquid suspension may then be loaded into the screw feeder and aerosolised into the gas stream 1914. The use of a liquid suspension may be particular advantageous for micron (1 to 50 micron) and submicron sized particles.

An alternate embodiment of the non thermal plasma reactor may be a planar arrangement of the dielectric barrier materials rather than the cylindrical arrangement described above with respect to FIGS. 1 and 19. In the planar arrangement two sheets of dielectric material (e.g. quartz or alumina) may be held together to form a closed channel between them for the gas stream. The outer surfaces of both dielectric sheets may have corresponding planar electrodes to generate the electric field intensity necessary for a non-thermal plasma to occur in the closed channel.

In yet another alternate embodiment of the non-thermal plasma reactor, an alternate means for depositing and/or condensing the polymer may be used. An array of fine mesh of a suitable, inert material may be used to collect the polymer by deposition and/or condensation upon the mesh elements and/or mesh fibers. The mesh array may be suitable for use in the non thermal plasma reaction zone 116 or downstream 120 of the plasma reaction zone 116. Alternatively a cold trap may be positioned in the downstream condensation/deposition zone 120. The cold trap may have actively cooled surfaces to condense and/or otherwise deposit the polymer/s from the gas phase.

It will be readily appreciated that the examples to providing a non-thermal plasma by a DBD apparatus and operation as described here allow a person/s skilled in the art of chemical processing, high voltage and plasmas to design, construct and operate a suitable DBD apparatus or a means for generating a non-thermal plasma reaction zone. Furthermore person/s skilled in the art may readily design, construct and operate DBD apparatus of different non-thermal plasma volumes and processing capacities from the inventions described herein. For example apparatus may be designed to process halogenated compounds at the rate of at least 10's of kilograms per hour.

It will be appreciated that in addition to the halogenated compounds described above, the invention may be readily applied to the following halogenated compounds: fluorocarbons, halofluorocarbons and hydrofluorocarbons, chlorinated saturated fluorocarbons, brominated saturated fluorocarbons, halons, halogenated organic compounds, chlorofluorocarbons, dichloroethane, dichlorodifluoromethane, dichloroethane, dichloromethane, trichloromethane (chloroform), chlorinated alkanes, chlorinated hydrocarbons, PFOS (perfluoroctanesulfonic acid), derivatives of PFOS (perfluoroctanesulfonic acid), PFOA (perfluorooctanoic acid), derivatives of PFOA (perfluorooctanoic acid), HCB-(hexachlorobenzene), PCB (polychlorinated biphenyls), brominated flame retardants (HBCD, TBBPA) and halogenated pesticides including but not limited to dieldrin, aldrin, DDT, 2,4 D and 2,4,5 T. Furthermore the following halogenated compounds may also be processed by the invention/s: C₂Cl₂H₄, CCl₂F₂, CFCl₂Br, CF₃Br, CF₃H, CHClF₂, C₄F₁₀, CH₂F₂, CF₃H, C₃F₈, C₃F₈O, CF₃Br, CF₂ClBr, CF₂CFH, C₂H₃F, C₂H₂F₂, C₂H₂F₂ and CCl₃F.

It will also be readily appreciated that the invention/s may also be applied to non-halogenated carbon based compounds and/or organic compounds in general. It will also be readily appreciated that mixtures of halogenated compounds, non-halogenated carbon based compounds and/or organic compounds may also be processed with the invention to provide polymers and other products.

Although the invention has been herein shown and described in what is conceived to be the most practical and preferred embodiments, it is recognized that departures can be made within the scope of the invention, which are not to be limited to the details described herein but are to be accorded the full scope of the appended claims so as to embrace any and all equivalent assemblies, devices, apparatus, articles, compositions, methods, processes and techniques.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises” where they appear.

It will further be understood that any reference herein to known prior art does not, unless the contrary indication appears, constitute an admission that such prior art is commonly known by those skilled in the art to which the invention relates.

1. A process for producing a polymer from a gas stream containing a halogenated compound, comprising:
providing the gas stream including the halogenated compound and a carrier gas portion, the carrier gas portion being suitable for producing a non-thermal plasma;
providing a non-thermal plasma reaction zone;
exposing the gas stream to the non-thermal plasma reaction zone; and
one or more of condensing and depositing from the gas stream the polymer.

2. A process according to claim 1, wherein the carrier gas includes an inert gas.

3. A process according to claim 2, wherein the inert gas is selected from the group consisting of helium, neon, argon, krypton and xenon.

4. (canceled)

5. A process according to claim 1, further including the step: selecting an alkane gas for a portion of the gas stream.

6. A process according to claim 1, further including the step: selecting an alkane gas for a portion of the gas stream when hydrogen is absent from the halogenated compound.

7. A process according to claim 5, wherein the alkane gas is selected from the group consisting of methane, ethane, propane and butane.

8. (canceled)

9. A process according to claim 1 further including the step: providing a hydrogen gas for a portion of the gas stream.

10. (canceled)

11. A process according to claim 1, further including the step: maintaining the gas stream at an approximate atmospheric pressure.

12. A process according to claim 1, wherein the halogenated compound is selected from the group consisting of one or more of fluorocarbons, halofluorocarbons and hydrofluorocarbons, chlorinated saturated fluorocarbons, brominated saturated fluorocarbons, halons, halogenated organic compounds, chlorofluorocarbons, dichlorodifluoromethane, PFOS (perfluoroctanesulfonic acid), derivatives of PFOS (perfluoroctanesulfonic acid), PFOA (perfluorooctanoic acid), derivatives of PFOA (perfluorooctanoic acid), HCB-(hexachlorobenzene), PCB (polychlorinated biphenyls), brominated flame retardants (HBCD, TBBPA), halogenated pesticides, dieldrin, aldrin, DDT, 2,4 D and 2,4,5 T.

13. A process according to claim 1, wherein the halogenated compound is selected from the group consisting of CCl₂F₂, CFCl₂Br, CF₃Br, CF₃H, CHClF₂, C₄F₁₀, CH₂F₂, CF₃H, C₃F₈, C₃F₈O, CF₃Br, CF₂ClBr, CF₂CFH, C₂H₃F, C₂H₂F₂, C₂H₂F₂ and CCl₃F.

14. A process according to claim 1, wherein the halogenated compound is selected from the group consisting of chlorinated alkanes, chlorinated hydrocarbons, PFOS (perfluoroctanesulfonic acid), derivatives of PFOS (perfluoroctanesulfonic acid), PFOA (perfluorooctanoic acid), derivatives of PFOA (perfluorooctanoic acid), HCB-(hexachlorobenzene), PCB (polychlorinated biphenyls), brominated flame retardants (HBCD, TBBPA), halogenated pesticides, dieldrin, aldrin, DDT, 2,4 D and 2,4,5 T.

15. A process according to claim 1, wherein the halogenated compound is selected from the group consisting of dichloroethane, dichloromethane and trichloromethane

16. A process according to claim 1, wherein the polymer is a uniform polymer.

17. A process according to claim 1, wherein the polymer has a Polydispersity Index in the approximate range of 1 to 2.

18-19. (canceled)

20. A process according to claim 1, further including the steps:
dissolving the polymer in tetrahydrofuran; and
recovering the polymer with tetrahydrofuran.

21. (canceled)

22. A process according to claim 1, further including the step: recovering and purifying of polymer products using selective solubility and precipitation methods.

23. A process according to claim 1, further including the step:
selecting a concentration of the halogenated compound in the gas stream of less than approximately 2%.

24. (canceled)

25. A process according to claim 1, wherein in a proportion of a HF acid in a total of all gas phase products in the exposed gas stream is less than or approximately equal to 4.4%

26. A process according to claim 1, wherein a proportion of a halogen from the halogenated compound is bound within the polymer up to approximately 58%.

27. (canceled)

28. A process according to claim 1, wherein the halogen is selected from the group consisting of chlorine and fluorine.

29-30. (canceled)

31. A polymer produced according to the process of claim 1.

32. A polymer having at least one of:
a NMR spectra of the figures;
a gel permeation chromatography graph of the figures; or
one or more of a number average molecular weight, a weigh average molecular weight, and a Polydispersity index of the tables herein,
wherein the polymer is substantially not cross-linked.

33-38. (canceled)

39. A non-thermal plasma reactor apparatus for production of a polymer from a gas stream containing a halogenated compound, comprising:
a means for generating a non-thermal plasma reaction zone;
a means for providing the gas stream to the non-thermal plasma reaction zone; and
a means for depositing a polymer from the gas stream to a deposition surface at one or more of within the non-thermal plasma reaction zone and downstream of the non-thermal plasma reaction zone.

40-43. (canceled)

44. A process according to claim 6, wherein the alkane gas is selected from the group consisting of methane, ethane, propane and butane.
